(19) United States
(12) Patent Application Publication
(10) Pub. No.: US 2020/0283136 A1
(43) Pub. Date: Sep. 10, 2020

(54) Method and System for Providing Blockchain Enabled Secured and Privacy-Data Meta-Market Support in an Agricultural Products Marketplace Through Drone Uniform Integrated Services Using Personal Flying Vehicles/Drones with Coaxial Lift Pinwheels and Multi-Wheel Drive Pinwheels

(71) Applicant: UZIP, INC., Austin, TX (US)

(72) Inventors: Luan Duy Nguyen, Austin, TX (US); Anh Ngoc Vu, Ho Chi Minh City (VN)

(21) Appl. No.: 16/813,705

(22) Filed: Mar. 9, 2020

(30) Foreign Application Priority Data
Mar. 7, 2019 (VN) 1-2019-01161

(51) Int. Cl. B64C 27/20; B64C 27/08; B64C 39/02; H04L 9/06

(52) U.S. Cl. CPC B64C 27/20; B64C 27/08; G06Q 50/02; H04L 9/0637; B64C 2201/044; B64C 39/024

(57) ABSTRACT

An aerial vehicle and methods of use. The aerial vehicle including a central rotor assembly configured to provide vertical thrust. A fuselage having a longitudinal axis mounted to the central rotor assembly. A plurality of rotors smaller than said central rotor mounted to said fuselage by a frame, includes a propeller, an electrical motor, an electronic speed controller, a flight controller (means for controlling the rotation speed of the central rotor and the smaller rotors). A propulsion system for powering said central rotor, said smaller rotors and said flight controller. Together with control and monitoring systems, the aerial vehicle system enables a new agricultural ecosystem for providing small farmer access to global markets.

### RELATED APPLICATIONS

The present claims priority to Vietnamese Provisional Patent Application Serial No. 1-2019-01161, entitled “Individual Flying Vehicles Using Coaxial Lift Pinwheels and Multi-Wheel Drive Pinwheels,” filed on Mar. 7, 2019, said provisional patent application being here expressly incorporated by reference in their entirety.

### FIELD OF THE INVENTION

The present disclosure relates to automated and robotic mechanical systems for performing agricultural and related financial and commerce operationas and, more particularly, to a method and system for providing blockchain-enabled meta-market support in an agricultural products marketplace. Additionally the present disclosure provides a method and system for providing blockchain-enabled meta-market support for secured and protected privacy data in an agricultural products marketplace through drone uniform integrated services using personal flying vehicles/drones with coaxial lift pinwheels and multi-wheel drive pinwheels, including, but not limited to crop management, surveillance, and monitoring, as well as executing contractual processes for the distribution, storage, and financial transaction concerning agricultural products.

### BACKGROUND OF THE INVENTION

Personal transportation has become a necessity in today's life. In addition to personal trips from one place to the other, transportation enables greater socio-economic opportunities. In the past, Takeoff and Landing (VTOL) aircrafts has been used to provide regional transportation. Latter-day, active research and development continue on “flying cars” and other forms of personal air transportation.

This PAV which has the configuration using multiple rotors is introduced to satisfy the need to develop and manufacture personal aircraft that can take-off and land vertically and dynamically, in small size for use in urban environments with complex terrain. In addition to the purpose of transportation, the PAV can also be used for leisure, sports, flight training and security, defense, search and rescue missions requiring high mobility. The configuration could also be applied for average to large scale of UAV,

The multirotor copters (or multicopters) in general have more advantages than others do: simpler in mechanism than helicopters, highly flexible, easy to control, safer and able to take off and land vertically. With the advance of technologies such as more efficient motors, higher energy density batteries, faster and smaller flight controller, multicopters are widely used now for various applications in life besides pleasure, such as monitoring environment, soil erosion, radiological inspection, inspecting fruit orchards and vineyards, search and rescue missions, firefighting and others. However, Large-scale multicopters that can carry extreme heavy payload or passenger are still rare in today market besides some homemade projects or still in development because of technical limitations of the electrical propulsion system. Current affordable battery technologies still have their limitation on energy density, which greatly effects on battery fraction on the aircraft weight. Low energy density batteries create an enormous challenge for the aircraft to be able to meet operating conditions with heavy payload and long flight time.

The coaxial propulsion system includes the 2-stage contra-rotating propellers. This design reduces the size of the main rotor (with that of conventional helicopter have the same total take-off weight) as both of the rotor disks create vertical thrust. In addition, since no tail rotor is needed for the purpose of suppressing the torque, it reduces the size of the aircraft and all of the shaft power contributes for main vertical thrust, which has advantages in terms of vehicle compactness. Taking into account both aerodynamic and mechanical losses, a coaxial rotor system is just as efficient as a conventional configuration. However, in forward flight scenario, it has a typically higher profile and parasite drag (from the exposed mast and controls system), which in turn reduces the forward flight performance of the coaxial rotor system. The coaxial rotor design increases mechanical complexity of the rotor hub and control scheme, so it may drive up maintenance costs.

From needs relating to new designs for unmanned aerial vehicles derive needs that could rise upon addressing such technology needs for agricultural markets. Agriculture production, distribution, and sales have to grow effectively and efficiently as the population grows by 34% to 9.1 billion till 2050 that means food production needs to increase by 70%. Small and medium scale farmers are the producers of local natural farm. According to FAO (Farm and Agriculture Organization), the world counts with over 500 million farmers, most of them are small farmers.

However, the traditional business models which exist today led the major farm brands and agricultural corporations to push the small and medium-scale producers and processors of agricultural products out from the local markets. The globalization mechanisms help them to tighten their domination easily, using their own material and immaterial resources, on the markets of countries with less developed economies. Long in transparent supply chains of agricultural products delivery used by transnational corporations, have led to a decline in the consumption of local products. That has led, in its turn, to a reduction of the number of small and medium scale farms turning the heavily fragmented market of agricultural products into the market of large corporations and intermediaries.

Additionally, fundamental aspects of today's ecommerce platform flaws are rooted in the nature of our monetary system and the need for centralized parties to handle payment transactions. Since humanity have moved from a peer to peer transactional economy to an online payment transactional economy, trusted authorities were required to keep accounts to make sure of no double spending or other fraud to happen. This led to a centralization of power, money supply and control over payment systems to a few like banks, credit card companies or payment processor companies like Paypal. Sadly, this trust is routinely abused. Furthermore the massive collection of data gets frequently sold, stolen or leaked to other entities without compensation for customers.

Blockchain Crypto Coins (BCC) platforms seek to provide a decentralized marketplace platform where everyone has equal access to a global market of production and distribution of agriculture goods with traceable supply chain (origin of production) for the large and small producers and consumers together with modern financial instruments &amp; technologies. With Blockchain Crypto Coin the buyers will get access to the unlimited range of the original, high-quality and low-priced goods and the sellers will get the steady flow of favorable consumers and other participants of the supply chain can offer their services passively (after verification) and edited into the smart contract depending on the needs of every individual trade offer. So, there is a need to provide the ability to employ the promise and power of a blockchain enabled marketplace.

These needs coalesce to a profound need for a method and system for providing blockchain enabled secured and privacy-data meta-market support in an agricultural products marketplace through drone uniform integrated services using personal flying vehicles/drones with coaxial lift pinwheels and multi-wheel drive pinwheels.

The many advantages of the combination of multirotor and coaxial rotor configuration, including vertical lifting capabilities combined with simple control mechanism and small footprint, if available to the general public, could revolutionize the transportation industry, and, in particular, the transportation of agricultural products to make accessible a greater degree of products and services for the suppliers and purchasers both regionally and globally.

### BRIEF SUMMARY OF THE INVENTION

The disclosed subject matter provides for a method and system for providing blockchain-enabled meta-market support in an agricultural products marketplace through drone uniform integrated services, additionally the present disclosure provides a method and system for providing crop management, surveillance, and monitoring, as well as executing contractual processes for the distribution, storage, and financial transaction concerning agricultural products.

To combine the advantages of the two VTOL models, a combination of multirotor and coaxial rotor system were introduced. In this concept, the multirotor is used as the control system and also contributes to the vertical lifting force, and the coaxial rotor system contributes to the majority of the main vertical lifting force. The multirotor is used for maneuvering the PAV by adjusting the thrust of individual rotor by that control the rolling, pitching and yawing moment of the vehicle. This will help to remove the complex control mechanism of the coaxial rotor system and increase the maneuverability of the aircraft. In addition, the configuration is supposed to be safe because two systems work independently of each other, so when one of them has problems, the other one will help the vehicle landed safely in an emergency situation. The configuration has the smallest footprint than the conventional helicopter or VTOL vehicle has fixed wing.

In accordance with one embodiment, the multirotor and coaxial rotor locate on the same central axis on different stages with the fuselage in the middle. The multirotor is on top of the fuselage and the coaxial rotor is below the fuselage. In another embodiment, the multirotor is below the fuselage and the coaxial is on top of the fuselage. Three components have the same centralized vertical axis in both embodiments.

In some embodiments, duct rotor housing is used for the rotors of multirotor or and coaxial rotors because of the huge contribution to parasite drag of the exposed rotor mast and hub. The hovering ducted rotor system is generally more aerodynamically efficient than a single rotor alone because the tip losses now are significantly reduced. Moreover, it is also useful in the operation of ducted rotary systems in urban environments that dense with high-rise buildings and complex terrains because of the low possibility of the rotors striking objects or personnel. One more advantage of using the duct is it will reduce the noise signature of the rotor system.

The PAV utilize a hybrid powertrain using both electricity and fossil fuel to provide energy for propulsion systems. The multirotor is powered by electricity from battery or generator and coaxial rotor is driven by mechanical power from internal combustion engine fueled by fossil fuel. The combustion engine could provide electric energy for multirotor by a coupled generator. Two system also could operate independently for replacing each other in case of failure of one system. In case of both systems unable to operate normally, ballistic recovery system is deployed to vertical land.

Because of its unique configuration, the PAV maneuvers easily in urban environment and capable of operating in confined space. The PAV is easier to operate, control and orient than fixed wing attached aerial vehicles.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGUREs and examples are not meant to limit the scope of the present subject matter to a single embodiment, but other embodiments are possible by way of interchange of some or all of the described or illustrated elements and, further, wherein:

FIG. 1 shows a computer interface screen for controlling operation of an unmanned aerial vehicle for crop spraying as an novel aspect of the presently disclosed subject matter;

FIG. 2 illustrates an auto-charging station feature enabling full auto operation of an unmanned aerial vehicle within the scope of the presently disclosed subject matter;

FIG. 3 illustrates a multi-spectral image of a crop for use with the presently disclosed unmanned aerial vehicle control system to achieve improved crops;

FIG. 4 illustrates operation of a real-time kinematic global positioning system for use in precisely positioning and controlling unmanned aerial vehicles;

FIG. 5 illustrates a side-schematic cross-section few of the presently-disclosed unmanned aerial vehicle subject matter wherein multiple rotors are positioned above a coaxial rotor;

FIG. 6 illustrates a perspective view showing an embodiment of the disclosed subject matter with multiple rotors atop a coaxial rotor;

FIG. 7 illustrates a perspective view of the disclosed subject matter showing multiple rotors atop a coaxial rotor;

FIG. 8 illustrates a side-schematic cross-section view of the disposed subject matter with a coaxial rotor atop and multiple rotors;

FIG. 9 depicts a perspective view showing an embodiment of the disclose subject matter with a coaxial rotor atop multiple rotors;

FIG. 10 shows a side-schematic cross-section view showing an embodiment of the disclosed subject matter with a coaxial rotor atop multiple rotors;

FIG. 11 shows a side schematic view presenting an embodiment with multiple rotors atop a coaxial rotor and unattached skirt bag of an unmanned aerial vehicle;

FIG. 12 shows a perspective view of the disclosed subject matter with multiple rotors atop a coaxial rotor and an attached skirt bag;

FIG. 13 shows a hybrid power train system for an unmanned aerial vehicle system according to the present disclosure;

FIG. 14 provides a side schematic cross-sectional view of the disclosed subject matter wherein a delivery unmanned aerial vehicle appears;

FIG. 15 presents a perspective view of an embodiment of the disclosed subject matter wherein a delivery unmanned aerial vehicle is positioned with multiple rotors atop a coaxial rotor;

FIG. 16 presents a side-schematic cross-sectional view of the presently disclosed subject matter for a spraying unmanned aerial vehicle with multiple rotors a top a coaxial rotor;

FIG. 17 shows a perspective view of an embodiment of the disclosed subject matter for providing a spraying vehicle with multiple rotors atop a coaxial rotor;

FIG. 18 illustrates a conceptual diagram showing the produce market supply chain characteristics for transmission of supply chain products and services to various sites;

FIG. 19 provides a diagrammatic representation of a blockchain crypto coin marketplace into which the presently disclose subject matter may find utility;

FIG. 20 provides an interface for the formation of a smart contract, including smart contract advisor;

FIG. 21 illustrates a catalog for selecting a product for which the present disclosure supports the creation of a smart contract that may be fulfilled by an unmanned aerial vehicle as herein described;

FIG. 22 illustrates aspects of forming a smart contract using the teachings of the present disclosure;

FIG. 23 illustrates an aspect of a smart contract editing panel in process in accordance with the teachings of the present disclosure;

FIG. 24 depicts an exemplary unmanned aerial vehicle satellite communications configuration in accordance with the teachings of the present disclosure;

FIG. 25 shows aspects of the presently disclosed subject matter for a carrier-based ranging system for precision range detection and positioning according to the present teachings;

FIG. 26 shows use of a presently disclosed real-time kinematic system using a GSM/3G communications network;

FIGS. 27 and 28 illustrates steps for building a mission flight for spraying a field using the GSM/3G satellite communications platform as described in FIG. 26;

FIGS. 29 and 30 illustrates steps for spraying fields of crops using the real-time kinematic information downloaded from a GSM/3G network consistent with the teachings of the present disclosure;

FIG. 31 shows a structure for the drones-as-a-service business model that the presently disclosed subject matter makes possible;

FIG. 32 illustrates an overview of data flows in a privacy lock system for use with the subject matter of the present disclosure incorporating a privacy lock blockchain functionality;

FIG. 33 illustrates a baseline a meta-data process when a new customer registers for use of the blockchain encrypted fulfillment system in accordance with the present disclosure;

FIG. 34 presents a Chen-style entity-relationship model for use with this present disclosure for enabling a student to enroll in a university as here in described;

FIG. 35 presents a diagram derived from the entity-relationship models as described above in FIG. 34;

FIG. 36 provides a schematic of a consumer request process for use with the teachings of the present disclosure including a privacy lock blockchain functionality, as herein described;

FIG. 37 illustrates a process of the presently disclose subject matter for publishing real time data to a message queuing telemetric transport (MQTT) process according to the present teachings; and

FIG. 38 illustrates an exemplary embodiment of a MQTT process consistent with the teachings of the present disclosure for use in the drone communication system of FIG. 37.

### DETAILED DESCRIPTION OF ILLUSTRATIVE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

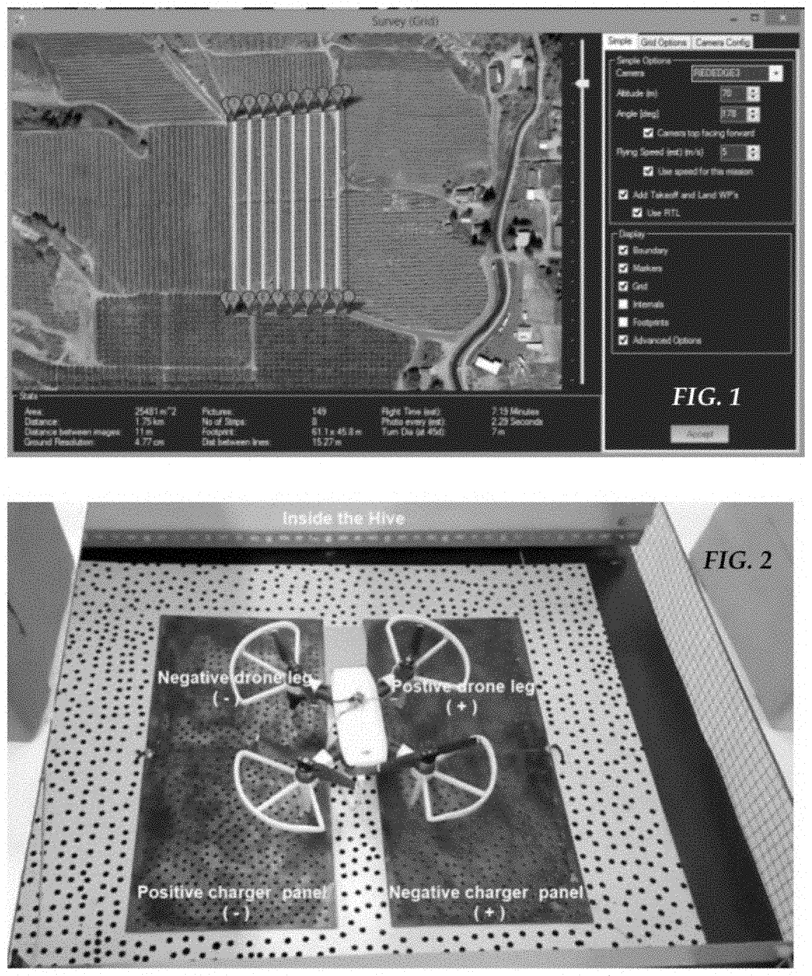

FIG. 1 shows a computer interface screen for controlling operation of an unmanned aerial vehicle for crop spraying as an novel aspect of the presently disclosed subject matter. Drone use in farming and agriculture: Precision agriculture is a farming management concept that uses drones for agriculture to measure, observe, and respond to variability found in crops.

Drone Use in Business

Filmmaking/videography/photography from heights

Short services (repairs)

Shipping/delivery of parcels/spare parts/food

Geographic mapping

Inspection of sites (construction sites/industrial zones)

Storm tracking/safety reporting

Risk monitoring (insurance companies in times of disasters)

Advertising/marketing (banners/delivery of merchandise)

Internet service

Drone use in the military: Security, Search and Rescue, Monitoring, Communications,

The global agriculture drone market is expected to reach USD 3.77 trillion by 2024, according to a new report by Grand View Research, Inc.

GPS mapping field—precision agriculture, better plantation with crop rotation strategies, daily progress of crops

Collecting data using pictures, sensors

supply water, fertilizer, or chemical when needed, check for signs of disease, monitor crop health, and save time in the process.

Technologies on hand—Our current AQ10 Drone to spray and fertilize:

Efficient

Easy for uses

Good price

Good technical services

Autonomous flight, mission set up by smart mobile, tablet . . . .

Auto-return in case of recharging the batteries and pesticide tank

Takeoff Weight: 25 kg

Payload: 10 kg

Flight time: 15-20 minutes

Speed: 0-8 m/s

Flight altitude: 0-50 m

Efficiency: 0.5-1 ha/10 minutes

Save labour cost: 50%

Save water: 97%

Save pesticides: 60%

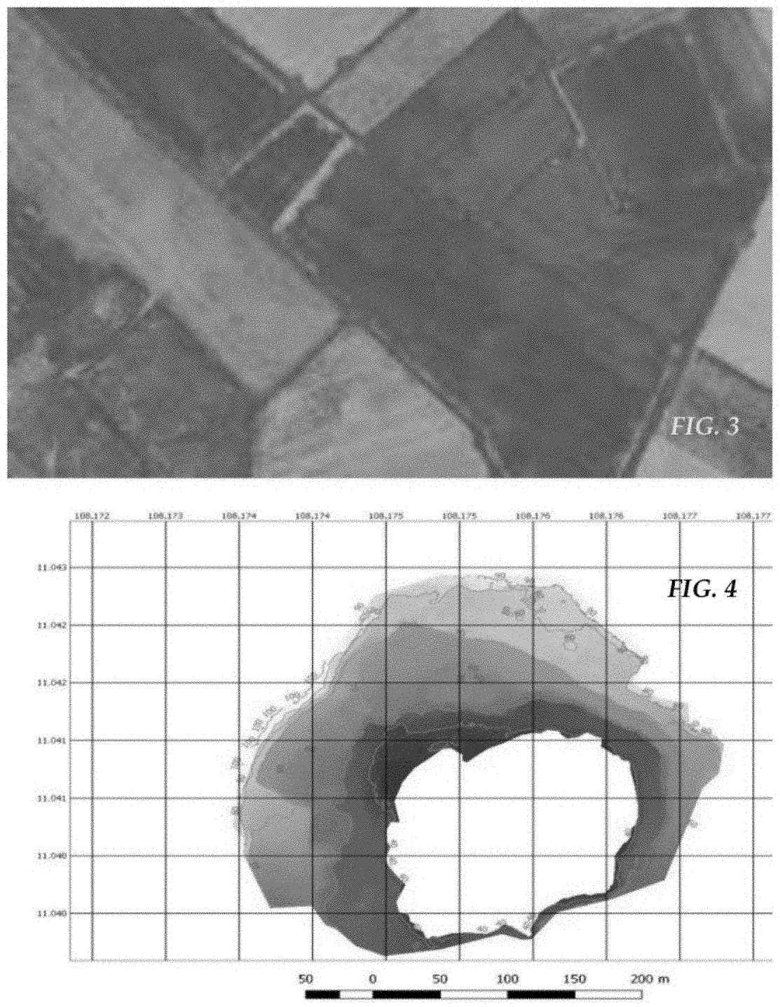

FIG. 2 illustrates an auto-charging station feature enabling full auto operation of an unmanned aerial vehicle within the scope of the presently disclosed subject matter;

Auto-charging with “go-home” station feature

Fully auto-operation of Drone

Position adjustment by image processing

3) Developing technologies

JWCLab AQ40-dH drone

AQ40-dH drone is based on our current AQ40 drone from JWCLab.

AQ40-dH drone addresses many shortcomings of its competitors currently available in the market.

Disadvantages of most current drones:

Limitation of batteries capacity: usually 10-30 minutes.

Low life cycle: 500-1000 cycles

Long time for recharging

Need a lot of batteries for full day operation

Solve the hardest issue of drones with longer flight time and higher payload not currently available in the market !

Developing technologies—Current on the market: Agras MG-1 from DJI. The powerful propulsion system enables DJI's Agras MG-1 to carry up to 10 kg of liquid payloads, including pesticide and fertilizer. The combination of speed and power means that an area of 4,000-6,000 m² can be covered in just 10 minutes, or 40 to 60 times faster than manual spraying operations. New Hybrid Agriculture AQ40-dH drone with much higher payload and longer flight time

FIG. 3 illustrates a multi-spectral image of a crop for use with the presently disclosed unmanned aerial vehicle control system to achieve improved crops;

FIG. 4 illustrates operation of a real-time kinematic global positioning system for use in precisely positioning and controlling unmanned aerial vehicles.

RTK—GPS Mapping for plant

diseases, health with big data

Auto-actions for spraying,

fertilizing precisely.

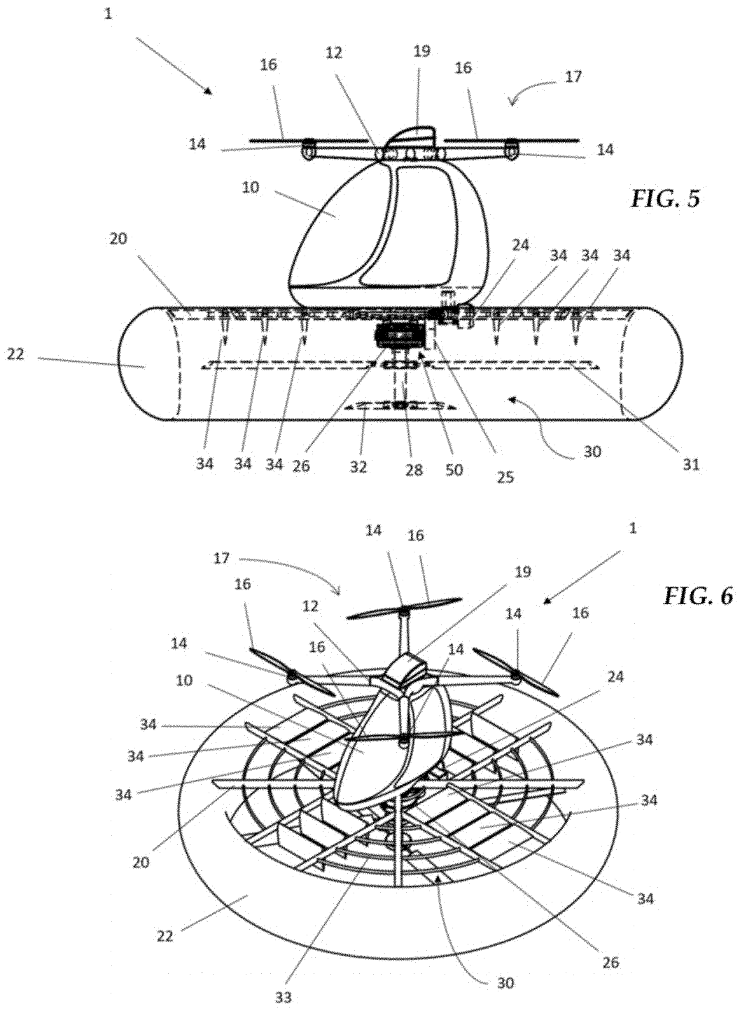

FIG. 5 illustrates a side-schematic cross-section few of the presently-disclosed unmanned aerial vehicle subject matter wherein multiple rotors are positioned above a coaxial rotor.

Embodiment described herein illustrate a personal air vehicle (PAV) 1 with a central coaxial rotor system 30 and a multirotor system 17 in different position. More specifically, FIGS. 1-3 illustrate an example embodiment of the PAV in an assembled state which is the multirotor 17 on top of the fuselage 10 and the coaxial rotor 30 is below the fuselage 10. FIG. 4-6 illustrate another embodiment which the multirotor 17 are below the fuselage 10 and the coaxial rotor 30 is on top of the fuselage 10. The PAV is capable of vertical take-off landing (VTOL), the PAV 1 could fly up to 23000 ft and cover up to the distance of 218 miles or have maximum flight time of 3.3 hours.

The multirotor system 17, the central coaxial rotor system 30 and the fuselage 10 have the same a longitudinal axis. In embodiments, the multirotor rotors 16 are fully or partly in the horizontal projected area of the central coaxial rotor system 30. This configuration helps the PAV 1 has a compact design that have small footprint, estimated to be as same as an average of one SUV in the case of 1 seater. The vertical distance between the multirotor system 17 and the central coaxial rotor system 30 is chosen for optimized aerodynamic performance and vehicle compactness to be suitable for urban environment.

The PAV 1 has multirotor rotors 16 driven by electric motors 14, the numbers of the multirotor rotors 16 and motors 14 could be three or more. The multirotor rotors 16 could cover or not by multirotor rotor duct 18. The electric motors 14 are joined with a fuselage 10 by cylinder or streamlined shape arms 12 to reduce drag as upper frame. A parachute or a ballistic recovery system is stored in parachute container 19 on the center and top of the arms 12 to increase safeness of the PAV 1. The lower part of the PAV 1 is connected with the fuselage 10 by the beams 20. The PAV 1 has duct fan housing 22 connected to the fuselage 10 by beams 20 as lower frame which has doughnut shape to reduce drag. The duct fan housing 22 is empty inside, as the internal space of the duct 22 could stores extra fuel, batteries or mission-based equipment. The duct 22 acts as a floating device which makes the PAV 1 capable of take-off and landing on water. A reciprocating engine 24 is mounted on the lower frame with rubber shock absorbers (not shown). A transmission box 26 is mounted below the frame and connected with the reciprocating engine 24 through transmission belt 25. The coaxial rotor 30 which includes two counter rotating rotors, upper rotor 31 and lower rotor 32. The two rotors (upper 31 and lower 32) are driven by reciprocating engine 24 through a rotor mast 28 which connected to the transmission box 26. A protective net 33 fixed with the beams 20 covers the upper surface of the upper rotor 31. Lower frame beams 20 has control vanes 34 at PAV 1 left and right sides as well as front and back sides. The control vanes 34 are connected to the lower frames by hinges and servos (not shown) to adjust the control vanes 34 setting angles. The control vanes 34 could be approximately perpendicular with ground to control the inflow of the coaxial rotor 30.

FIG. 6 illustrates a perspective view showing an embodiment of the disclosed subject matter with multiple rotors atop a coaxial rotor.

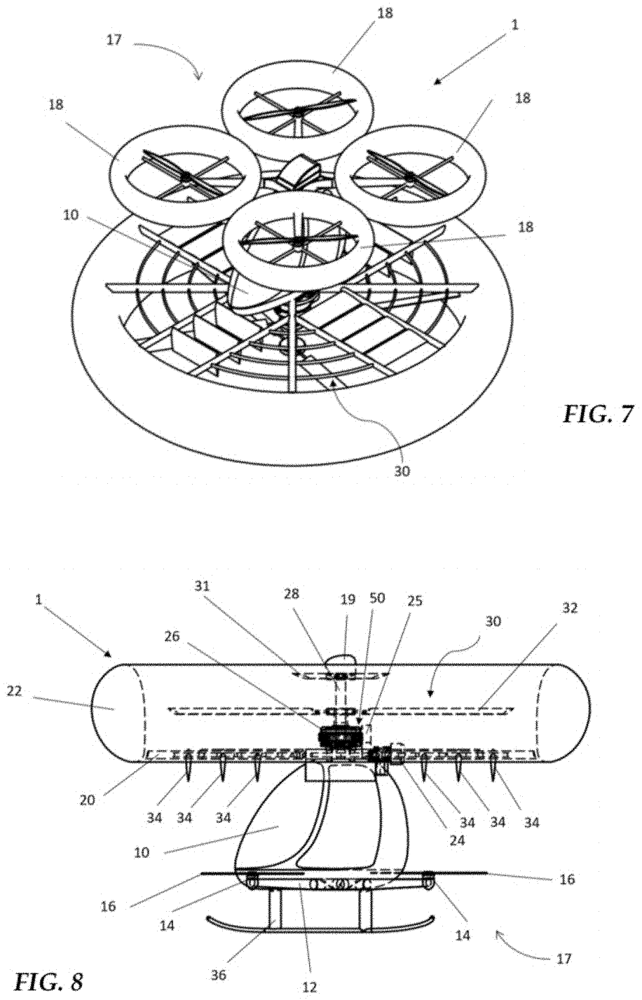

FIG. 7 illustrates a perspective view of the disclosed subject matter showing multiple rotors atop a coaxial rotor.

FIG. 8 illustrates a side-schematic cross-section view of the disposed subject matter with a coaxial rotor atop and multiple rotors.

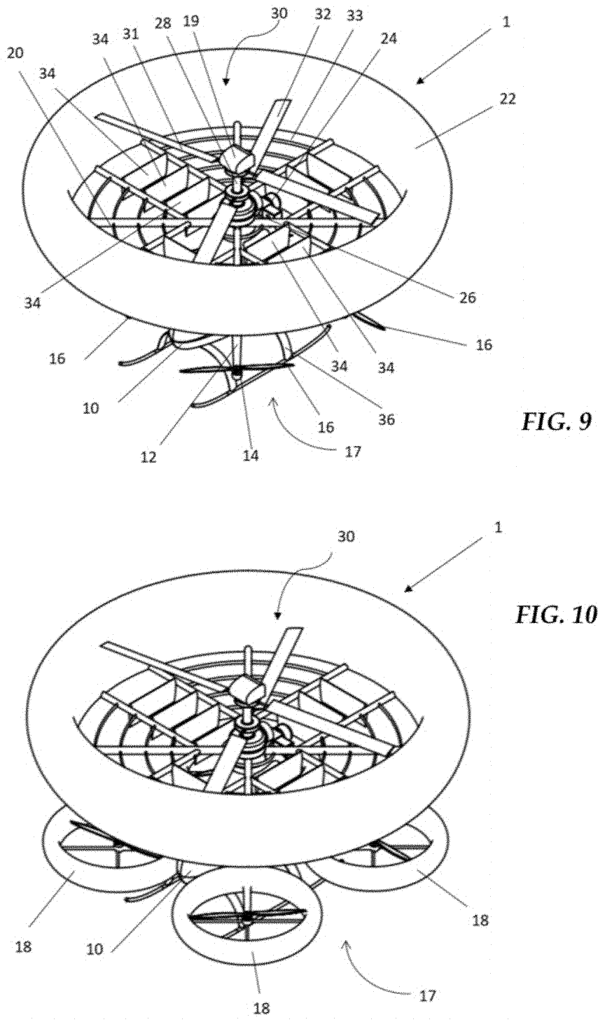

FIG. 9 depicts a perspective view showing an embodiment of the disclose subject matter with a coaxial rotor atop multiple rotors;

FIG. 10 shows a side-schematic cross-section view showing an embodiment of the disclosed subject matter with a coaxial rotor atop multiple rotors;

The coaxial rotor 30 which contains the upper rotor 31 and lower rotors 32. The coaxial rotor 30 is connected to the transmission box 26 by the rotor mast 28. On top of the rotor mast 28 is parachute container 19. The transmission box 26 is connected with reciprocating engine 24 by transmission belt 25. The transmission box 26 and reciprocating engine 24 are mounted on top of the fuselage by rubber vibration absorbers or trusts (not shown). The coaxial rotor 30 could have duct fan housing 22 which is supported by the upper frame beams 12 mounted to the top of the fuselage 10. Upper frame beams 20 could has adjustable control vanes 34 mounted at the outflow of coaxial rotor 30 in the front and back as well as in the left and the right of the fuselage 10. The lower frame arms 20 act support the three or more electric motors 14 which rotate the multirotor rotors 16. The multirotor rotors 16 could have multirotor rotor duct 18. The weight of the PAV is support by landing gear 36 on land.

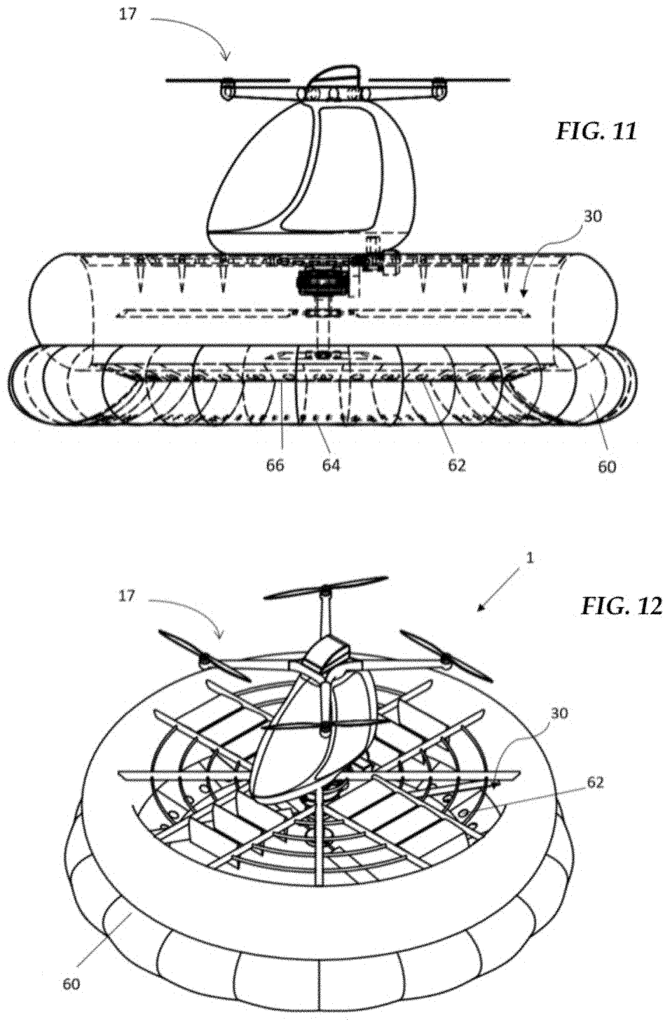

FIG. 11 shows a side schematic view presenting an embodiment with multiple rotors atop a coaxial rotor and unattached skirt bag of an unmanned aerial vehicle.

FIG. 12 shows a perspective view of the disclosed subject matter with multiple rotors atop a coaxial rotor and an attached skirt bag;

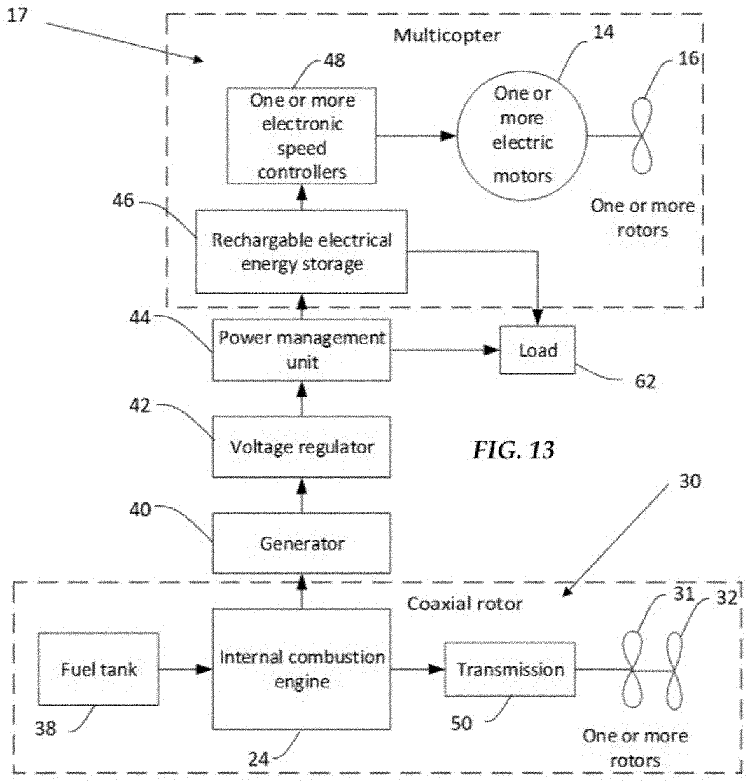

FIG. 13 shows a hybrid power train system for an unmanned aerial vehicle system according to the present disclosure. A skirt bag 60 is attached to below the duct fan housing 22 of the PAV 1 which has the coaxial rotor 30 below the fuselage 10. The skirt bag 60 is made by flexible, water resistant materials such as rubber. FIGS. 7A & 7B illustrates the state that the skirt bag 60 is filled with air. The coaxial rotor 30 blows the air through the oval or circle inlet holes 62 to the skirt bag 60 and the air then exits by outlet holes 64. A panel 66 is below the coaxial rotor 30. The skirt bag 60, the panel 66 and the terrain below the PAV 1 trap a cushion of air exited from the outlet holes. The air cushion has higher pressure than that of ambient air which produces lift that make the PAV float above any surface and types of terrain such as land, water, mud, ice, etc. and overcome waves and small obstacles. In this embodiment, the multirotor 17 create horizontal forces to maneuver the PAV 1 and also vertical force to raise the PAV 1 in emergency.

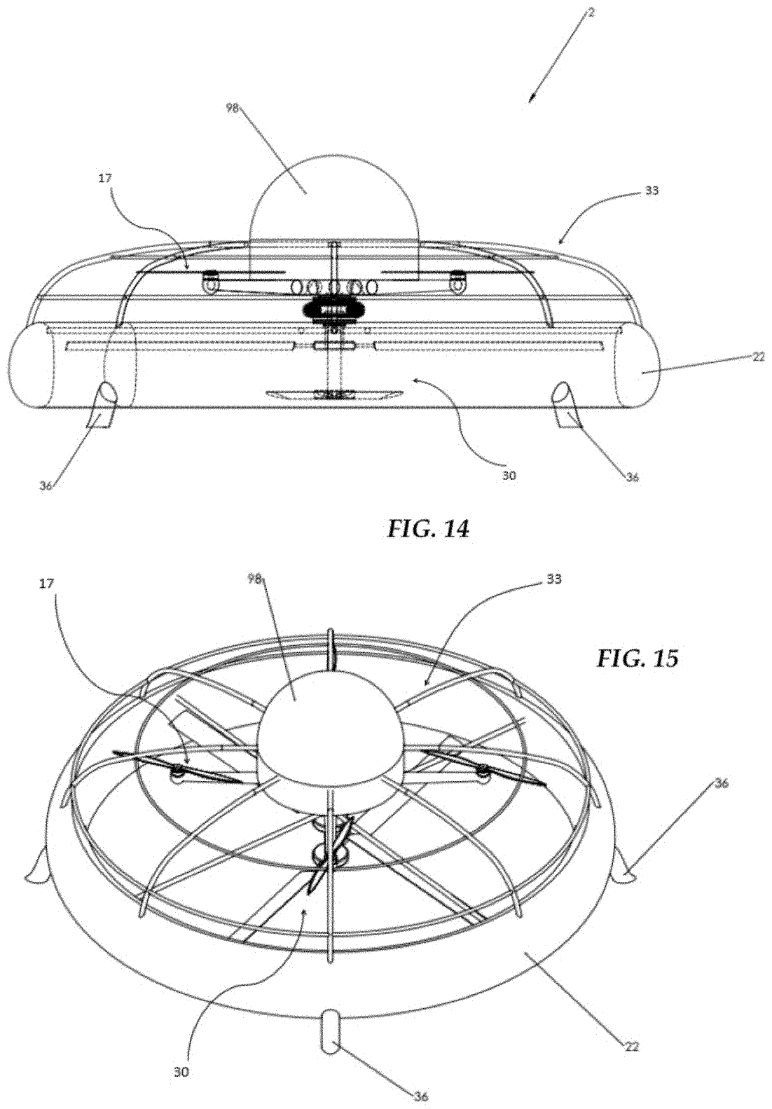

FIG. 14 provides a side schematic cross-sectional view of the disclosed subject matter wherein a delivery unmanned aerial vehicle appears;

FIG. 15 presents a perspective view of an embodiment of the disclosed subject matter wherein a delivery unmanned aerial vehicle is positioned with multiple rotors atop a coaxial rotor.

Embodiment described herein illustrate a delivery unmanned aerial vehicle 2 with a central coaxial rotor system 30 and a multirotor system 17 in different position. More specifically, FIGS. 9-10 illustrate an example embodiment of the delivery unmanned aerial vehicle in an assembled state which is product house 98 on top of the protective frame 33. The protective frame covers the multirotor 17 and the coaxial rotor 30 is below. The protective frame 33 stands on the duct 22 covering the coaxial rotor 30. The delivery unmanned aerial vehicle 2 is attached with landing gear 36.

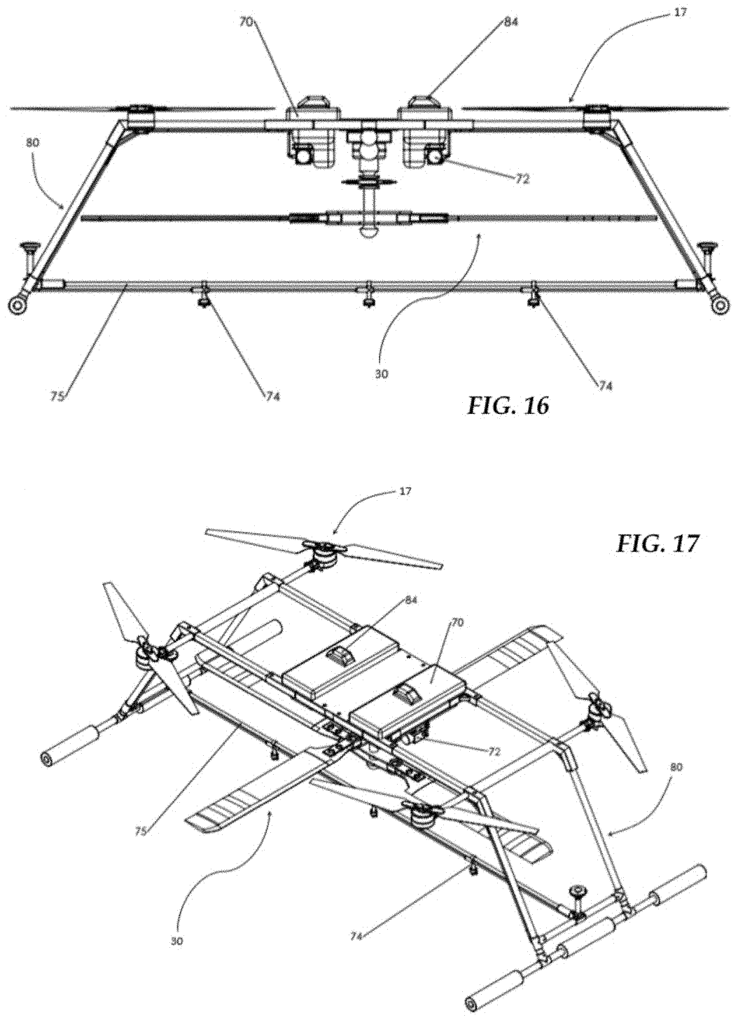

FIG. 16 presents a side-schematic cross-sectional view of the presently disclosed subject matter for a spraying unmanned aerial vehicle with multiple rotors a top a coaxial rotor.

FIG. 17 shows a perspective view of an embodiment of the disclosed subject matter for providing a spraying vehicle with multiple rotors atop a coaxial rotor.

Embodiment described herein illustrate a spraying unmanned aerial vehicle 3 with a central coaxial rotor system 30 and a multirotor system 17 in different position. More specifically, illustrate an example embodiment of the spraying unmanned aerial vehicle in an assembled state which is spraying liquid tank 70 on top of the standing frame 80. The tank 70 has handle 84 at the top. A pump 72 is attached to the bottom of the tank 70. The multirotor 17 is attached to standing frame at the top and the coaxial rotor 30 is below. A spraying bar 75 is attached to the standing frame 80 at the bottom. Position adjustable spraying nozzle 74 is attached to the spraying bar 75.

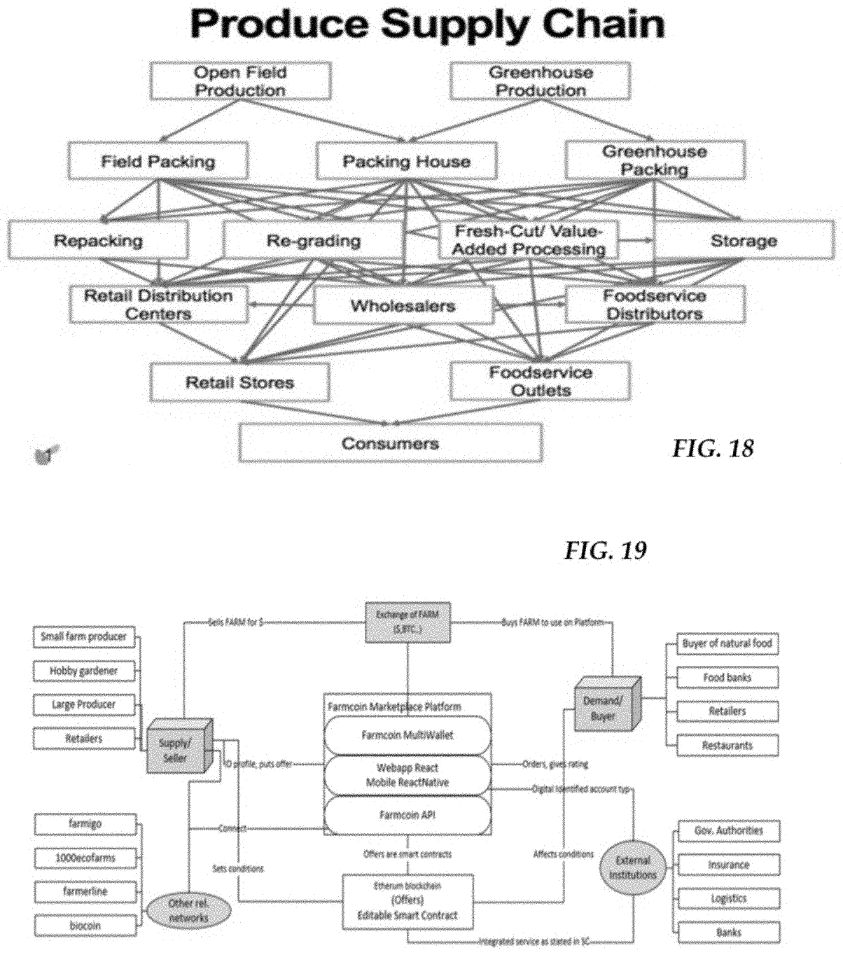

FIG. 18 illustrates a conceptual diagram showing the produce market supply chain characteristics for transmission of supply chain products and services to various sites.

Agriculture production, distribution, and sales have to grow effectively and efficiently as the population grows by 34% to 9.1 billion till 2050 that means food production needs to increase by 70%. Small and medium scale farmers are the producers of local natural farm. According to FAO (Farm and Agriculture Organization), the world counts with over 500 million farmers, most of them are small farmers (distribution FIG. 1.1).

However, the traditional business models which exist today led the major farm brands and agricultural corporations to push the small and medium-scale producers and processors of agricultural products out from the local markets. The globalization mechanisms help them to tighten their domination easily, using their own material and immaterial resources, on the markets of countries with less developed economies. Long in transparent supply (FIG. 1.2) chains of agricultural products delivery used by transnational corporations, have led to a decline in the consumption of local products. That has led, in its turn, to a reduction of the number of small and medium scale farms turning the heavily fragmented market of agricultural products into the market of large corporations and intermediaries.

All this leads to the fact that despite the fertile land, excellent climate and production opportunities, the small-scale farmer does not have the opportunity to sell his goods to the foreign market, or gives this function to the intermediary who solves this issue. In this case, the products are bought at a knockdown price and resold in rich jurisdictions much more expensive. Thus, the consumer does not have the opportunity to buy quality products at an adequate price, and the farmer cannot emerge from poverty. And this is a vicious circle.

E-commerce platforms have been one of the main successes of the internet bringing numerous advantages to its users like expanding reach of sellers, cheaper prices for buyers or the consumers' ability to share instant feedback for purchased goods. But these platforms work only well in countries that have a strong developed digital and logistical infrastructure and monetary stability leaving the two billion “un-banked” people who live in under developed countries excluded.

FIG. 19 provides a diagrammatic representation of a blockchain crypto coin marketplace into which the presently disclose subject matter may find utility. Additionally, fundamental aspects of today's ecommerce platform flaws are rooted in the nature of our monetary system and the need for centralized parties to handle payment transactions. Since humanity have moved from a peer to peer transactional economy to an online payment transactional economy, trusted authorities were required to keep accounts to make sure of no double spending or other fraud to happen. This led to a centralization of power, money supply and control over payment systems to a few like banks, credit card companies or payment processor companies like Paypal. Sadly, this trust is routinely abused. Furthermore the massive collection of data gets frequently sold, stolen or leaked to other entities without compensation for customers. Blockchain Crypto Coins (BCC) platform mission is to provide a decentralized marketplace platform where everyone has equal access to a global market of production and distribution of agriculture goods with traceable supply chain (origin of production) for the large and small producers and consumers together with modern financial instruments &amp; technologies. With Blockchain Crypto Coin the buyers will get access to the unlimited range of the original, high-quality and low-priced goods and the sellers will get the steady flow of favorable consumers and other participants of the supply chain can offer their services passively (after verification) and edited into the smart contract depending on the needs of every individual trade offer.

Potential and Blockchain Crypto Coin Marketplace
Potential of the natural farm market
Over $1 trillion healthy farm market worldwide (source: Euromonitor)
500 million farmer worldwide (source: FAO)
70% of customers in the United States willing to pay more for local products (source: ATKearney)
8669 of farmers markets in the United States. Growth by 98% over 10 years (source: USDA)
$602 billion: grocery retail sales in the United States (source: Statista)
12-16% of all farm will be sold online until 2023 (source: AT Kearney)
51% of customers believe that local products are underrepresented on the market (source: AT Kearney)
23% of agricultural sales are made on the farms with a turnover of less than $250 thousand (source: USDA)
Less than 16 cents for each dollar spent by the buyer on the products come to the farmer in the United States (source: VDACS).
Supply Chains have 50 times more data available in 2017 than 2012

Potential E-commerce market: E-commerce is a huge and rapidly expanding sector. In 2016 global sales for products and services purchased via the internet totaled approximately $1.9 trillion, representing around 8.7% of all retail spending. By 2020, online retail sales are expected to have grown to $4 trillion—with a compound annual growth rate (CAGR) of well over 20%. By that time, electronic commerce will make up about 14.6% of total retail sales.

Marketplace, blockchain distributed ledger—Blockchain Crypto Coin is a decentralized e-commerce platform, accessible by through web and mobile application, can be based on smart contracts protocol of a public blockchain (also known as permission-less blockchain) blockchain (such as Ethereum's blockchain or Hyperledger) or on any private blockchain (also known as permissioned blockchain). It recreates global infrastructure and functionality of major e-commerce corporations such as Amazon or Alibaba, allowing its users to buy/sell agriculture goods with traceable supply chain at a optimal cost during the growing, monitoring, distributing, and doing last miles delivery from farmers to the end consumers.

Most key functionalities of the ecommerce platform are similar to global ecommerce companies
Register account get identified and receive rights depend on type of account
Setup a store profile
List items for sale with payment and shipping options (Inventory and Order Management)
Order/buy products/goods
Review of products/seller/shops (Reputation Management)
Internal messaging system
Social network forum (Community/Tribe building)
Instant search with multiple filters
Escrow and arbitration
Integration to crypto exchange

Now Innovation happens by adding the disruptive blockchain technology to Blockchain Crypto Coin resulting in increased privacy, radically lower fees, zero censorship, from fiat excluded monetary circulation, integrating social and business processes through editable smart contracts between a large number of independent economic agents (farmers, buyers of natural farm, restaurants and grocery shops owners, members of buying clubs, manufacturers and distributors, logistics and transport companies, customs brokers, insurance companies, state authorities, customs and tax authorities) without trust to a single center or any member of the network.

E-commerce giants usually depend upon extensive servers to deal with traffic, which is efficient but enormous and expensive. This overhead is eliminated through blockchain technology by distribution of a shared distributed ledger among the blockchain miners (in case of using public blockchain(s) or among the “supernode” owners in case of private blockchain(s) who are paid for effectively maintaining the network.

The implementation of the Blockchain Crypto Coin platform involves creating of several basic functions essential for the quick and low-cost transfer of the main traditional types of economic interactions among various platform users: (explained further in this document)
Database in a distributed ledger—the blockchain;
E-commerce platform web &amp; mobile—the Marketplace;
Third party application integration API—Blockchain Crypto Coin API;
Multi-functional advanced crypto wallet—multi WALLET;
Own payment system—fast secure Digital Payment;
Remote user verification—decentralized Digital Identification;
System for smart contracts multisign multiple parties
editable Smart contracts;
System product provenance authentication—the transparent supply chain.

Each explained element of the Blockchain Crypto Coin Ecosystem that represents a tool is organically linked with the rest of the platform, but capable to operate as an independent element.

Digital remote identification, account verification, API—Full application of blockchain technology in business environment would be impossible without powerful and secure user identification. This is also known as Know Your Customer (KYC) process. For this reason a digital remote identification system is developed, where participants of a smart contract request verification from a voluntary third party (banks, notary, insurance company, and credit bureau) and execution of the contract happens only after approval. Every user is identified once and remains in the system as a digital entry forever. The identification can be done physically using driver license/passports at the third party's location, and/or a novel fingerprint and facial recognition using effectively with Artificial Intelligence (AI) and cloud technology.

There will be 3 types of accounts sellers, buyers, externals. Additionally, by adding third party application integration as part of the Blockchain Crypto Coin API other related networks are motivated to join the ecosystem and make use of its tools. Blockchain Crypto Coin benefits hugely of network effects so growing numbers of buyers, sellers, externals and similar networks to the platform is of utmost importance. A specific example of the intrinsic value of editable smart contracts is explained further in this document.

Wallet, Blockchain Crypto Coin (also known as BCC) circulation, Payment processing—The introduction of a Blockchain Crypto Coin (called “BCC”, number is limited mathematically and embedded in the source code) as a universal trading coin (that can be convert to fiats, also known as paper currencies used in the world; or that can be used as just an internal trading coin for internal use among the private groups or individuals who are the parties that already registered on the platform) and a technical blockchain infrastructure including a smart multi-currency wallet and a crypto payment processing service, leads to the simplification of settlements and the automation of processes, thus leading to the elimination of unnecessary resource wasting middlemen services. As a result, all members of the process (members of the chain of production, supply and consumption of farm) receive a significant increase in efficiency and reduction of costs.

The platform has a closed economy and interacts with the outside world through the exchange, where the BCC rate to other currencies and digital assets is determined. BCC is the basic asset on the platform. The value of the BCC depends on its demand, the ratio of BUY/SELL orders on the exchange.

Closed condition is an important point of monetary circulation. Closed condition means that the BCC will mostly apply for goods and services within the platform, i.e. without selling it for another fiat currency.

The goal is to create such a community on the platform and such value from participation in the community so that the duration of the BCC circulation (the number of transactions before entering the exchange for sale) was the maximum. Then the price of the BCC will be stable due to a decrease in the offer on the exchange; and in the deflationary model, together with an increase in interest and new users on the platform, it will lead to an increase in the price of the BCC in the long term.

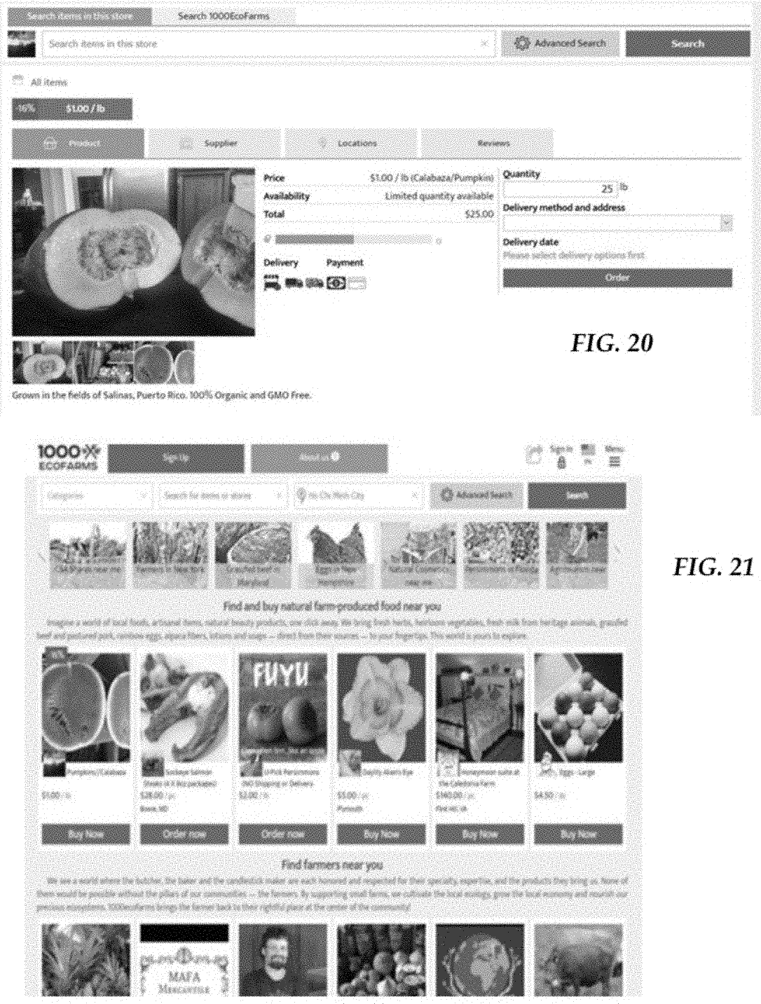

FIG. 20 provides an interface for the formation of a smart contract, including smart contract administrator. Administered Smart contract panel—Flexible administered smart contracts is an essential tool for creating offers on Blockchain Crypto Coin platform with the function of multiple inputs and outputs. It will have integrated horizontal and vertical connections between the transaction parties. A smart contract will be managed by one or more administrators. A hierarchy with rights will be configured by the user who created the smart contract. All administrators horizontally integrated into the current smart contract will have the same rights and cannot be removed or restricted in smart contract management rights after signing it. Each administrator will be able to create a vertically integrated private blockchain for personal service within the current smart contract. The administrators will not have access to private blockchain of another administrator. Additional parties/middlemen to the transaction can be invited by the administrators on their own initiative or on the basis of consensus, and become either participants or verifiers of the current smart contract. Middlemen that add real value for example are the category of entities, which include logistics companies, customs brokers, consignment warehouses, banks, insurance companies. These intermediaries allow you to carry out the necessary work, for example, qualitative delivery of cargo, its customs clearance (in the current reality, it is necessary to formalize relations with state bodies when crossing borders), and so on. Adding them into the smart contract automates many of the necessary delivery processes and in general offers efficiency, transparency and security.

Administered Smart contract panel—An open library of standard Smart contracts with an intuitive interface for connecting additional options will be created. Pre configured smart contract templates should have all countries regulation's as variables encoded. Creating and maintaining Smart contracts via panel will not require programming skills so working with Smart contract panel will be usable for everyone.

FIG. 21 illustrates a catalog for selecting a product for which the present disclosure supports the creation of a smart contract that may be fulfilled by an unmanned aerial vehicle as herein described. Traceability Goods Origin authentication system (Provenance system). As an ecommerce food marketplace having a traceable product history is very important. Blockchain's timestamping of each event will help prevent food fraud by recording each party's activities and making accessible all their required documentation. Timestamping also helps to accurate forecast pickups and delivery times. This digital footprint provides grocers with the data they need to give consumers full transparency of their foods and quickly minimize the impact of contaminated fresh produce in the event of our food borne illness outbreak. Faster response can prevent less people from getting sick or dying. Therefore, product and good origin authentication will be an essential condition for the offered goods by a smart contract. Having this option in smart contract included might results in having an external review of expert with undisputed authority in matters of origin authentication of goods that are subject of agreement signed. If external logistic for shipment is included in smart contract, it will be obliged to accept the goods only after confirmation of origin based on current smart contract.

In cooperation with all participants of the supply chain and experts of undisputed authority, collective effort is put to make the history of ownership/transaction traceable for every product. An effective “product origin authentication” system or protocol like origintrail.io need to be used, a system which is integratable with other blockchain based supply chain tagging systems. It is in collective interest to create a transparent supply chain for example by integrating with the electronic databases of public fiscal, customs and supervisory authorities will significantly limit the circulation of illegal, counterfeit and other illicit trafficking products and goods, thus making a significant contribution to the fight against economic crimes.

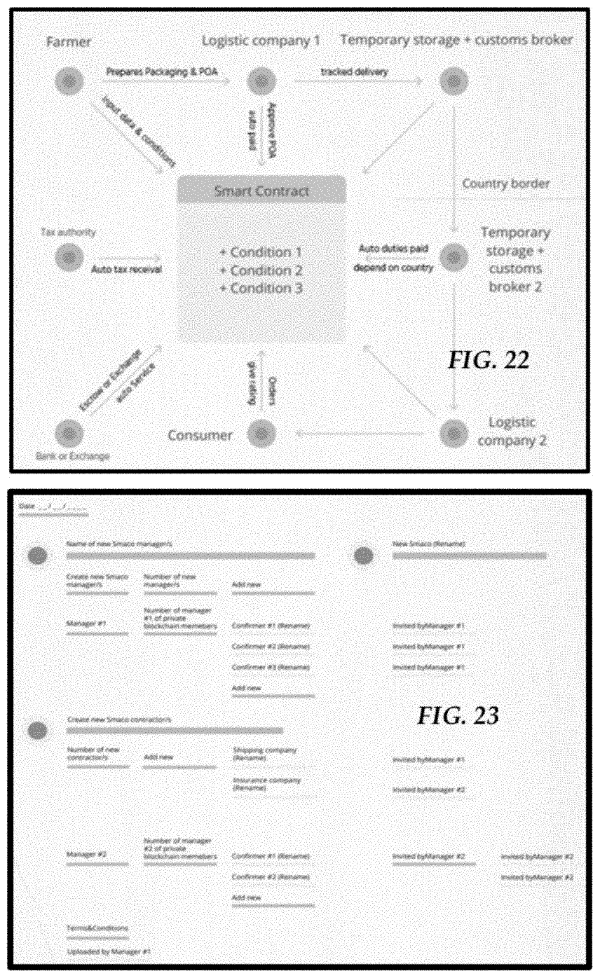

FIG. 22 illustrates aspects of forming a smart contract using the teachings of the present disclosure. Now let us consider a real case example of selling a product by a fully authenticated digital verified farmer using Blockchain Crypto Coin platform to consumers locally and globally. Therefore, he creates an offer on Blockchain Crypto Coin through the Administer smart contract panel.

He inputs following data into the “Standard offer template”
Enters persons who are eligible to edit this offer (smart contract)
Quantity (min-max order)
Product origin authentication condition included
Chooses POA method

Delivery Options
pickup at farmer location for no additional cost
adds external logistic provider of the verified list offering that service for that area which shall be added to the selling price, in this case DHL. Added shipping price presented by DHL and is dependent on factors like destination of buyer

Insurance Options
no extra insurance added
Price in $ per Quantity also shown in BCC

Payment Options
Farmer wants to get $ instead of BCC so he chooses an exchange service for a small fee of the verified list who automatically turns BCC to USD (US dollars as an example) and sends USD to bank account of Farmer.

Other standard settings like customs, tax are optimal preconfigured and he leaves them untouched. All fees for external services shall be deducted from the final payment.

After creation of the Smart contract, he enters additional product information/settings in an product offer configuration window for article descriptions like written information, pictures, contact details etc.

Buyers obviously have the possibility in getting in contact with the seller to negotiate different terms or ask questions before buying.

Once product gets ordered all participants variables are taken into consideration when the smart contract gets automatically executed. The fulfillment of the terms of the smart-contract is checked at every stage of the chain again. The conduct of operational activities in the collaboration with the mentioned intermediary structures through a smart-contract will automate the process and make it transparent. In addition, delivery monitoring is planned to include the use of other systems like sensors IoT, pressure or GPS on delivery to monitor compliance with the transport conditions of the product.

Options for Revenue Model:
Flat fee for listing items
Fee for extra functionalities like top listing promotion
Withdrawal fees
% fee for listing

FIG. 23 illustrates an aspect of a smart contract editing panel in process in accordance with the teachings of the present disclosure.

Technical and Social Mechanics
Technical Mechanics
Feature-rich blockchain enhanced BCC E-commerce platform system which functions can independently be used depending on purpose
BCC as a technical unit (gas) for the platform and BCC as a currency coin/token and its circulation for mutual settlements of economic agents on the platform.
The system of flexible construction of additional user-cases via smart contracts (digital contracts). Apply of one or more contracts to organize the supply chain in the B2B, B2C, P2P models.
The system of digital identification, reputation of economic agents
The ability to register their own manufactured goods on the blockchain platform
The “Product Origin Authentication System” to securely tag history of physical goods to blockchain and creating a transparent/traceable supply chain
The system of community building platform with social media like functions.
Social Mechanics
The independent currency of the community allows you to make mutual settlements in a convenient format, without borders and obstacles. Reliable fixing of payment and security.
The system of editable smart-contracts (digital contracts) allows user to conduct a supply chain from the manufacturer to the final consumer or distributor in the region transparently and with a minimum of complexities. In this case only the intermediaries that create value are involved in the chain.
Community platform accelerates collaboration for example through exchange of knowledge and information, offering and giving support.
Digital reputation/ratings/reviews motivates users to conduct honest long-term business and is a significant additional value in the market
An important aspect for the formation of supply chains and identification by the farmer of his goods in digital form.

The most significant functionalities are the following: feature-rich marketplace to offer and buy products, independent monetary circulation (Blockchain Crypto Coin BCC, multisig wallet), the possibility of building automatically-executable contracts (smart contracts), building transparent supply chains, transparent systems, possibility of integrating various other related networks through API.

All the advantages and user-cases of the platform can be divided into 3 large categories—social, economic and humanitarian.

User-cases—The social user-case—A social user-case is a way of using a platform that leads to an additional value, the cost of which cannot be measured directly.
Trust into irrefutable visible history of supply chain
Global farmer community building
Reducing routine work, automation of processes
Foster collaboration and dialogue between participants and leverage strengths
Seller own a shop profile and can receive ratings and valuable feedback

The economic user-case—The economic user-case is a way of using the platform, which leads to the mutual economic benefit of the target participants of the process. This is reflected in the mutual reduction of costs for the transaction process, as well as on the reduction of the cost of intermediaries in the price structure of the goods.
Lower prices for end consumer, higher income for producer
Removal of multiple middlemen services
Real time market data can be used strategically
Independent monetary circulation with BCC instead of fiat currency(ies)
Market players can be integrated through smart contracts efficiently
Passive offering of external services

The humanitarian user-case—The humanitarian user-case is the result of using the platform that leads to the solution of a significant humanitarian problem. Usually, this is the result of the effective work to solve economic and social problems in a particular territory. This is due to the fact that the nature of inequality is usually found in the economic and political structure.
100% traceable supply chain increase of food security
Increasing small-med scale producer income, productivity and knowledge
Increase economic production &amp; distribution of agriculture products
Global access to healthy nutrition
Drastically increase of sustainable production for small-scale farmers
Reduction of food waste

Being an evolving marketplace with a variety of essential and useful functions, Blockchain Crypto Coin ecosystem provides many advantages for users like access to latest technology, global marketing for business expansion, real time market data and a community to exchange information and support. Additionally, building a strong community will lead to accelerated synergies for all members of the ecosystem using co-operation with each other.

Blockchain Crypto Coin platform with its API is built so that all market participants of standard supply chain should be integrated. This platform hugely benefits of cooperation's as the power of smart contracts rises with network effects as optionality increases. The tools are meant to automate many routine processes for participants.

Potential collaboration and/or cooperation with the following organizations
Banks (external user identification, warranter of escrow service, exchange)
Insurance entities
Logistic entities
Other farm and/or drone platforms
Farms
Public fiscal bodies secure monitoring business activity (customs duties, taxes)

Key Factors that Will Motivate Future Partnerships
Quick integration into the realities of the new global digital economy with new sources of income through Blockchain Crypto Coin API
Risk of exclusion from the trade transaction chain and reduction of the customer base with global implementation of the blockchain
Automation of many processes
Actively take part of creating transparent supply chain which benefits whole ecosystem

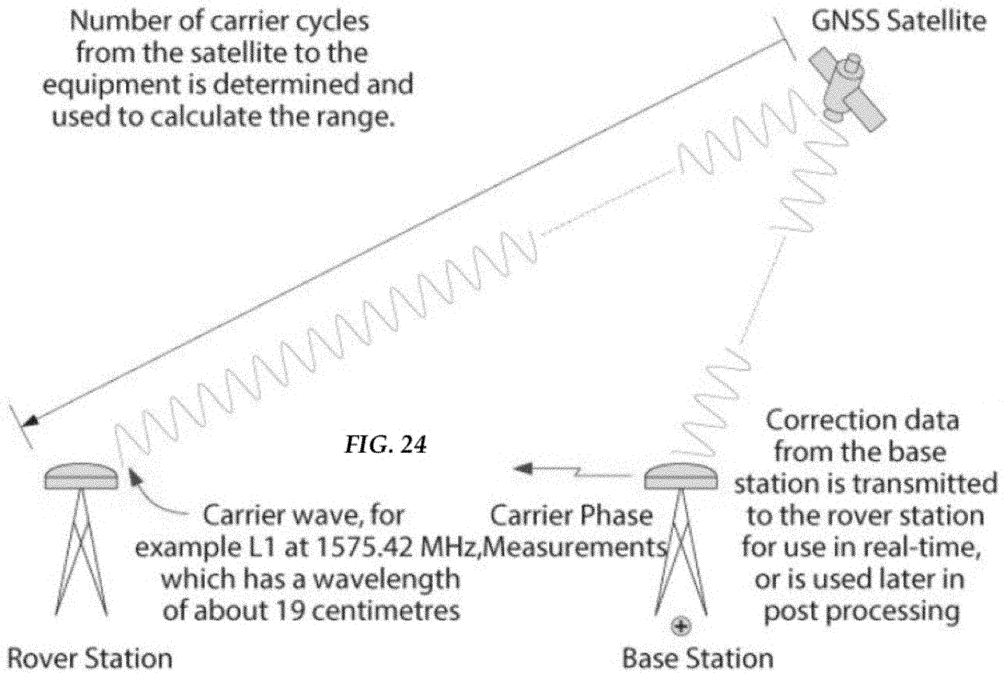

FIG. 24 depicts an exemplary unmanned aerial vehicle satellite communications configuration in accordance with the teachings of the present disclosure.

FIG. 25 shows aspects of the presently disclosed subject matter for a carrier-based ranging system for precision range detection and positioning according to the present teachings. RTK (Real-Time Kinematic) is a method to increase the precision of the GPS to centimeter level, as shown below. This system contents Rover (on the Drone) and a base station/central station (at a fixed known position on the earth). The schematic is shown as below:

RTK GPS Accuracy: What accuracy is RTK?

RTK is used for applications that require higher accuracies, such as centimetre-level positioning, up to 1 cm+1 ppm accuracy.

Range Calculation—At a very basic conceptual level, the range is calculated by determining the number of carrier cycles between the satellite and the rover station, then multiplying this number by the carrier wavelength.

The calculated ranges still include errors from such sources as satellite clock and ephemerides, and ionospheric and tropospheric delays. To eliminate these errors and to take advantage of the precision of carrier-based measurements, RTK performance requires measurements to be transmitted from the base station to the rover station.

A complicated process called “ambiguity resolution” is needed to determine the number of whole cycles. Despite being a complex process, high precision GNSS receivers can resolve the ambiguities almost instantaneously. For a brief description of ambiguities, see the GNSS Measurements-Code and Carrier Phase Precision section earlier in this chapter. For further information about ambiguity resolution, see the references at the back of this book.

Rovers determine their position using algorithms that incorporate ambiguity resolution and differential correction. Like DGNSS, the position accuracy achievable by the rover depends on, among other things, its distance from the base station (referred to as the “baseline”) and the accuracy of the differential corrections. Corrections are as accurate as the known location of the base station and the quality of the base station's satellite observations. Site selection is important for minimizing environmental effects such as interference and multipath, as is the quality of the base station and rover receivers and antennas.

Network RTK—Network RTK is based on the use of several widely spaced permanent stations. Depending on the implementation, positioning data from the permanent stations is regularly communicated to a central processing station. On demand from RTK user terminals, which transmit their approximate location to the central station, the central station calculates and transmits correction information or corrected position to the RTK user terminal. The benefit of this approach is an overall reduction in the number of RTK base stations required. Depending on the implementation, data may be transmitted over cellular radio links or other wireless medium.

RTK is real time system. The signal from base station is sent to rover continuously. The distance from Base station and Rover is 1-2 km and connected by Telemetry.
Business
   a) Sale agriculture drone
      +Drone is expensive to farmer
      +Mission flight need to be accuracy->need RTK->need to invest more for
         RTK system->increase price of the solution up to 50%.
      =>Initial investment is high
   b) Provide spraying services
      +Need people understand plant, pesticides, fertilizer, having good relationship with local
         authorities, and Vietnamese government.
      +Management of sale, technical services . . . .
      =>We should choose selling drone or providing spraying services.

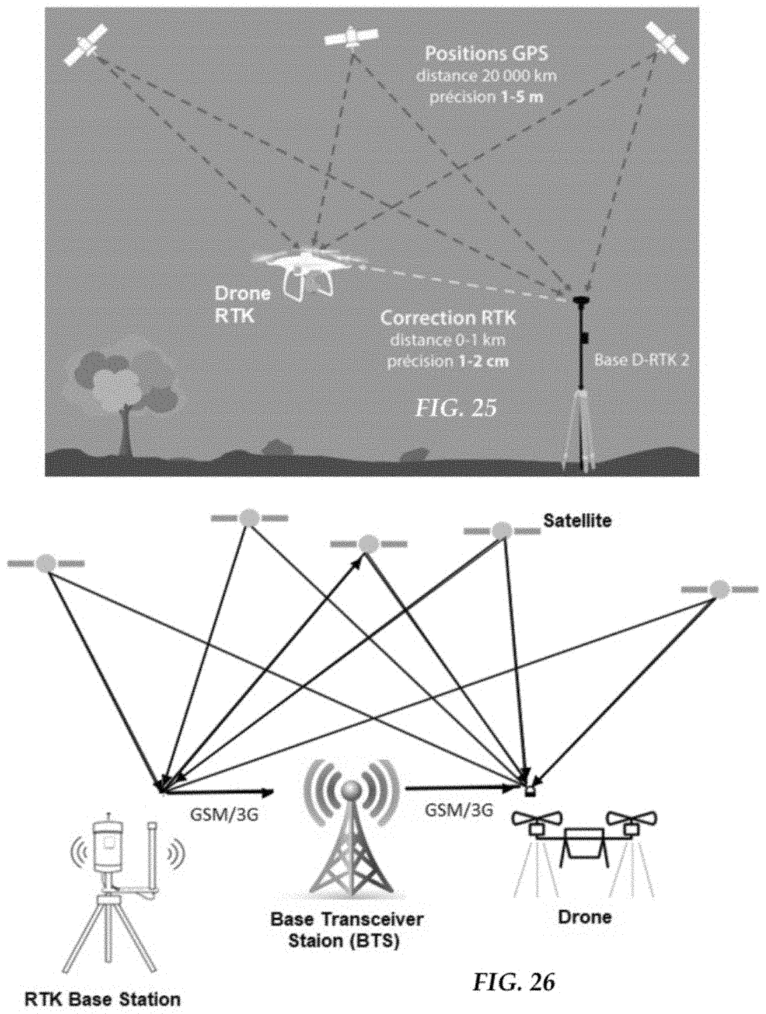

FIG. 26 shows use of a presently disclosed real-time kinematic system using a GSM/3G communications network. RTK does not need to be real time system, by GSM/3G connection, The distance from Base station and Rover is 100 km++. FIG. 9.3: RTK using GSM/LTE-M connection. Information from RTK can be sent to drone through GSM/3G or satellite.

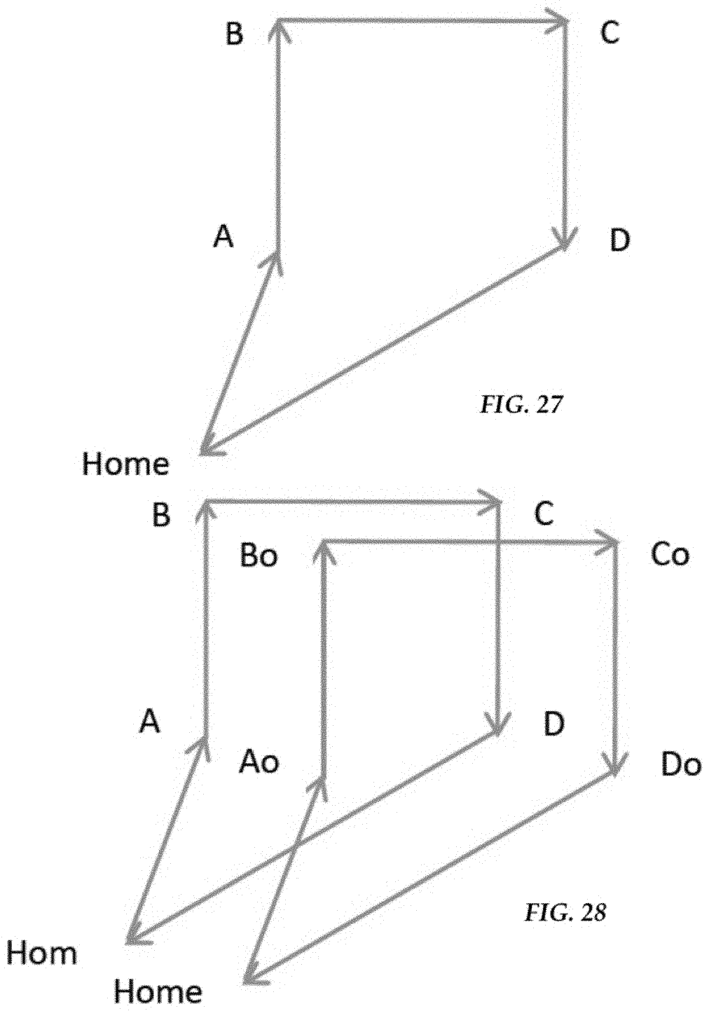

FIGS. 27 and 28 illustrates steps for building a mission flight for spraying a field using the GSM/3G satellite communications platform as described in FIG. 26. Step 1&2 is to build up the mission flight for spraying. Step 1: Drone takes mission flight ABCD offline from GSM/3G. Step 2: Correct the mission flight ABCD by using RTK information downloaded from GSM/3G. The mission flight AoBoCoDo is saved in smart phone device for the next use.

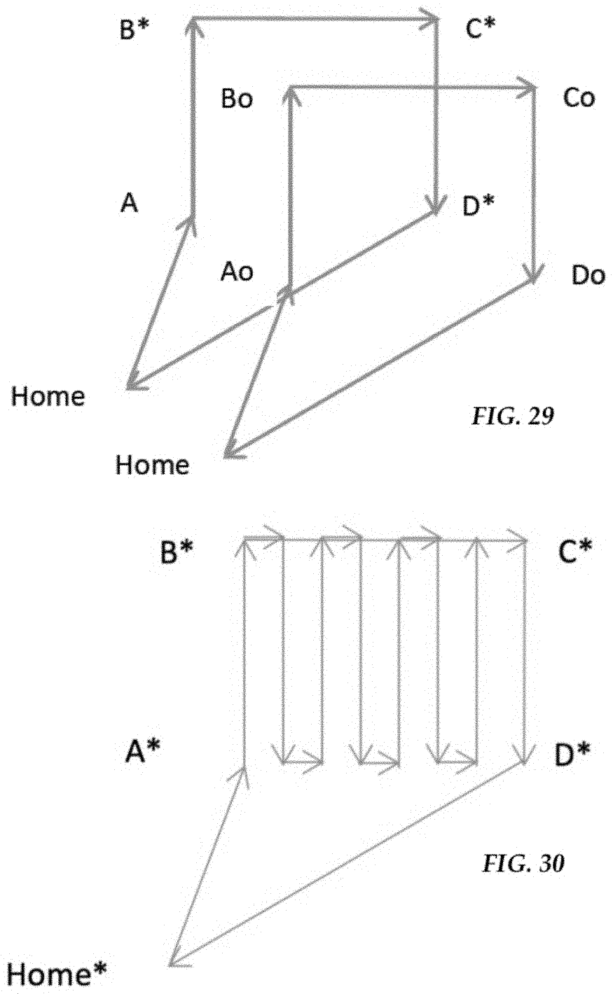

FIGS. 29 and 30 illustrates steps for spraying fields of crops using the real-time kinematic information downloaded from a GSM/3G network consistent with the teachings of the present disclosure. Step 3&4 is operation of spraying at fields. Step 3: Download the mission flight AoBoCoDo from smart phone device. Correct the mission flight AoBoCoDo by using RTK information downloaded from GSM/3G to have A*B*C*D. Step 4: scan the spraying field A*B*C*D* and carry out the mission flight offline from GSM/3G.

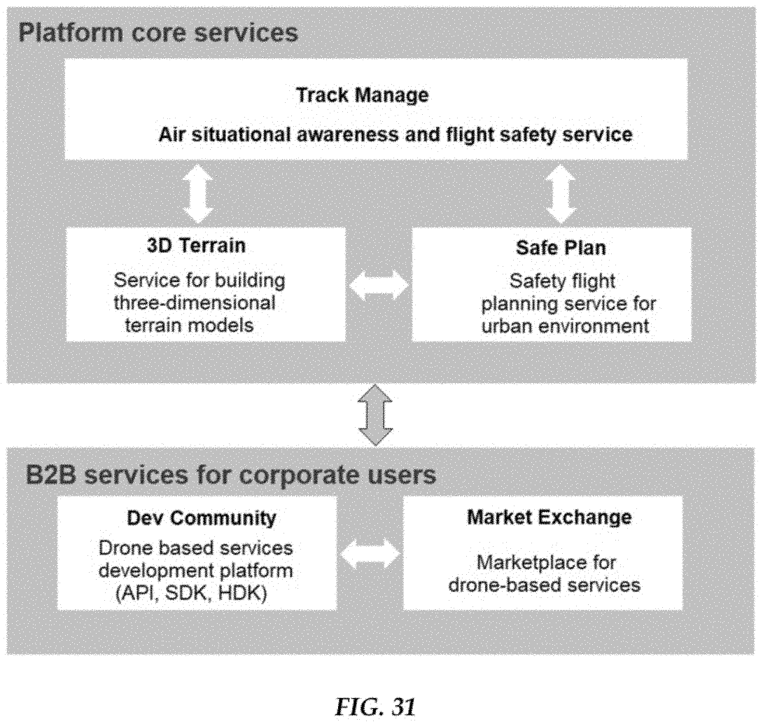

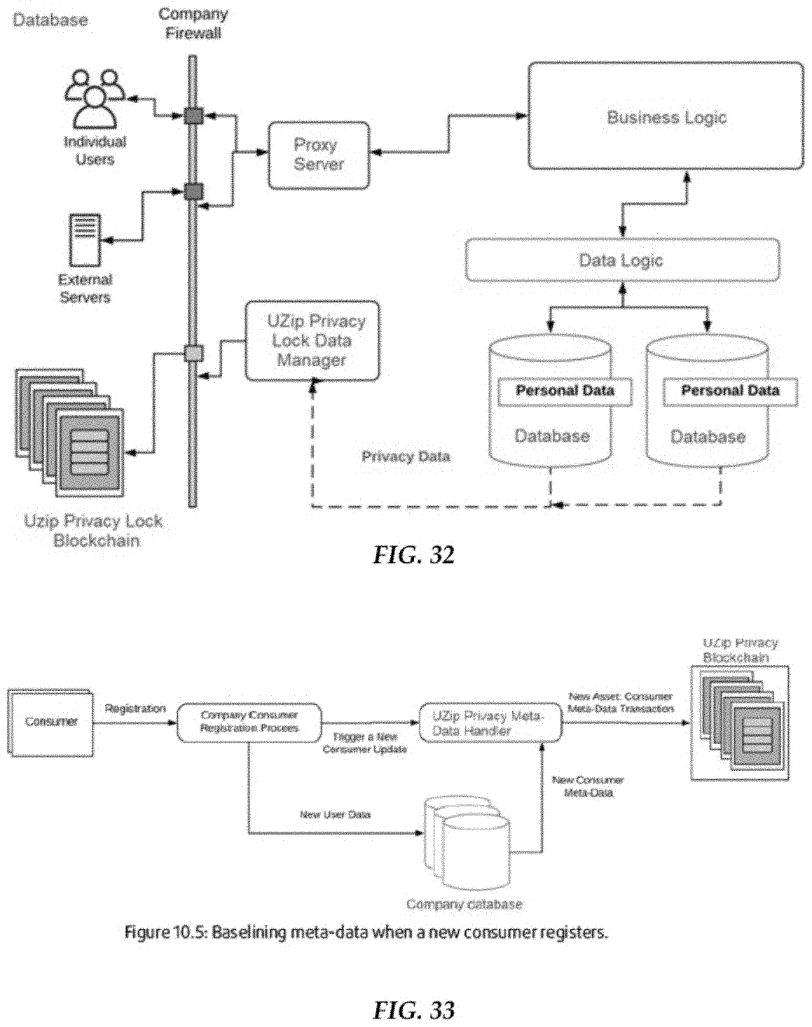

FIG. 31 shows a structure for the drones-as-a-service business model that the presently disclosed subject matter makes possible. DevCommunity is a development platform with developer community toolkits and an economic engine for easy commercialization of additional to-be-developed services and for the facilitation of the growing BCC coin usages. Tool kits include, but not limited to, API, SDK, HDK, BCC coin and digital wallets plug-ins, and web services (including GitHub repository, etc.

Revenue model: charges based on the percentage of each transaction using our BCC coins.

Competitors: No one has currently implemented a uniform integrated solution in the market.

VR-AR-Recording: The service creating art video and art photography recordings using the Virtual Reality and Augmented Reality technologies. The AR-VR-Recording service provides video filming planning using the virtual realty (VR) and the augmented reality (AR technologies on top of the three-dimensional terrain model, checking the planned shooting for safety in challenging environments, to carry out shooting “in several takes” with subsequent spatial “gluing” of the footage into a continuous video clip. This service delivers a novel organization of a complex aerial shooting of artistic material for cinematographic, media, advertising, presentational and similar needs.

The AR-VR-Recording software composed of:
Planning software for Windows/MacOS and on Android/iOS;
Shooting software under Android/iOS;
Spatial gluing software component of video content as a standalone application for Windows/MacOS and as a plugin for Adobe Premier.

Revenue model: Payment in BCC coins is charged for advanced functionality (built-in purchases in applications) and for Adobe Premier plugin. Also charges in BCC xoins can be made by selling integration module with Adobe Creative Cloud.

Competitors: Individual component of this AR-VR-Recording exists as a professional expensive solution for filmmakers. There are no solutions available to the “ordinary” users.

InfraInspect: The infrastructure inspection service by providing survey planning in the optical, infrared, wifi and radio band environment using a three-dimensional terrain model

The InfraInspect service provides survey planning in the optical, infrared, Wi-Fi, and radio band environment using a three-dimensional terrain model. It also checks the planned survey for safety in challenging environments, manages the survey, and visualizes the results of the survey by means of a three-dimensional model.

The InfraInspect service delivers a novel organization of airborne imaging capability in different ranges of technological facilities, infrastructure facilities, radio sources, ionizing radiation with visualization of imaging results by means of 3D terrain model. This service is designed to control the state of infrastructure objects, measure energy and spatial parameters of transmitters, to control cellular and broadcasting networks, to carry out electromagnetic environment assessment and to control the radiation background.

It includes the following software and hardware features:
Software features:
Planning software for Windows/MacOS and for Android/iOS;
Shooting software for Android/iOS;
Visualization software of shooting results for Windows/MacOS/Linux.
Hardware feature: Onboard radio measuring complex with working frequency range up to 6 GHz, designed for installation on any drones in the market. At the beginning optimized for UZip/JWCLab drones and starting with DJI Phantom (Matrice 200 is recommended).
Revenue model:
Software licenses;
Performance of measurements on demand;
Leasing services of the developed complexes;
Development of new measuring complexes on the basis of drones.
Competitors: As far as the software for optical and infrared imaging is concerned, similar functionality has been implemented by leading drone manufacturers such as DJI (dji.com) from China. This service can target of smaller drone manufacturers and/or owners of self-made/homeware drones.
Market/Exchange: The service to organize interaction between drone owners, drone pilots, and customers who need drone services. The MarketExchange service organizes interactions among drone owners, drone pilots and customers of drone operations. It accommodates offers and business transactions among drone owners and pilots for various types of survey/measurement and customers' requests for these related types of work. This service creates a drone services marketplace on a website that allows people to find each other to transact using BCC coins for different drones services.
Revenue model: Commission in BCC coins taken from each transaction. Discounts for users if other services from DUIS are used. Competitors: No one has implemented a uniform integrated solution in the market.

FIG. 32 illustrates an overview of data flows in a privacy lock system for use with the subject matter of the present disclosure incorporating a privacy lock blockchain functionality.

UZip Privacy Lock (UPL) as a novel privacy lock for the BCC Platform to address privacy and security protection and to satisfy current and future related global regulations. The UZip Privacy Lock (UPL) introduces a blockchain-backed privacy protection component on the BCC platform, that enables businesses to bring their data systems into compliance with many privacy business requirements and regulations, including but not limited to the California Consumer Privacy Act (CCPA). It is a comprehensive, commercial package of utilities for businesses and government agencies seeking privacy regulatory compliance under at least the CCPA act that took effect January 2020. The UZip Privacy Lock is the first blockchain-based solution in the market to respond to this important opportunity, and another example of innovative application of blockchain technology from the UZip Network

Background information—the challenge of identity theft and Blockchain as a privacy tool. Registering website accounts and purchasing goods online is an everyday activity in the era of high speed Internet and digital commerce. Less common, is awareness of how our personal information and transaction data is monetized by the tech industry, advertisers, and e-commerce platforms. Trading and selling of user data has become a highly lucrative business. This drives an associated demand for access to personal information, creating additional risk around how businesses and platforms handle privacy issues. Online businesses and social media platforms may be selling user data to third parties without first seeking consent and without disclosure to affected users. At the same time, sophisticated hacking schemes are capable of breaching data systems at private companies and public institutions and stealing personal information about consumers, which is then sold for profit.

UZip Privacy Lock is designed to be a click-and-deploy, cost effective way to bring existing data systems into compliance with current and future consumer privacy laws globally. The goal of UZip Privacy Lock is to enable our BCC platform and other platforms to deploy a simple toolkit that addresses the data management, reporting, storage, and tracking requirements of consumers privacy regulations. Rather than incurring significant expense to reengineer complex data systems, UZip Privacy Lock strategically applies distributed ledger technology to existing systems. Harnessing the power of blockchain technology, the UZip Privacy Lock delivers both privacy and transparency features crucial to the data systems underpinning businesses and online platforms.

A focal point of the UZip Privacy Lock is on eliminating costly expenses for consumers privacy business requirements and regulation compliance that arise from trying to re-engineer complex IT data systems. The exciting UPL innovation: integrating blockchain (distributed ledger) technology into existing systems, without requiring their re-engineering and associated costs. This creates a traceable and verifiable methodology for data system compliance.

Blockchain as a privacy tool: Blockchain is a form of distributed ledger technology (DLT). At its core, blockchain and other DLTs are encrypted accounting tools that are highly effective in tracking digital processes, managing accounting records and transaction history, and providing data security and privacy protections. Blockchain technology provides critical digital infrastructure for information systems that wish to achieve trusted data and trusted workflow outputs.

As relates to privacy protections in data systems, blockchain is the ideal technology for automating the processes related to user inputs, processing of user data, and system outputs. Privacy problems arise when user data or meta-data is taken from data systems and sent to third party systems without the user's consent. Blockchain technology makes it possible to automate data inventory management and the tracking of data flows on a trusted ledger. Automation in data tracking can be used to automate reporting processes, such as may be required to satisfy CCPA reporting requirements. Enforcement of privacy laws like CCPA will likely center on the ability of company's to demonstrate compliance, reinforcing the importance of robust data inventory management and tracking mechanisms, such as those offered by UPL.

The UZip Privacy Lock (UPL): a novel concept and implementation. The UZip Privacy Lock (UPL) is a software toolkit focused on bringing businesses covered by CCPA into compliance with the privacy law. UPL is the first product offering leveraging blockchain technology to provide CCPA compliance. Drawing on years of commercial software development and implementation, the UZip Network team has developed a sophisticated architecture for the UPL that combines blockchain and data storage functions. UZip Privacy Lock is a toolkit that includes these core features:

Data Inventory Management—Many of the regulatory requirements in the CCPA focus on tracking consumer data as it permeates data systems. In order to achieve CCPA compliance, businesses will need to employ robust digital tools to reliably track data flows in and out of the data systems they control. UPL offers an easy-to-deploy blockchain tool for this. Once deployed, all data inputs and outputs as well as data logs can be tracked and archived on an immutable blockchain Ledger of Record “LoR”. This assures that data records cannot be tampered with or altered by hackers. Data records written to the blockchain may be queried by system administrators in real time, and can be used to generate reports on data management activities and CCPA compliance.

Data Archiving and Reporting—UZip Privacy Lock enables real time auditing of data tracking and data logs, which can be used to generate reports. Again, since the CCPA includes requirements for data reporting and disclosures to users, this tool will be highly useful to businesses that seek to issue regular reports on data usage. UPL enables businesses to generate a number of standard forms, and can be customized to accommodate any desired form of reporting.

Dashboard and Control Monitoring—The UZip Privacy Lock provides dashboard features to help users manage the UPL toolkit and to handle their data privacy concerns. Dashboards may be customized to accommodate a variety of needs and to improve user experience.

The technology of privacy to satisfy current and future related regulations. The situations outlined above lead directly to the following requirements for the CCPA:

a) Data must be inventoried and tracked; and

b) Consumer requests must be tracked.

Tracking personal data in a single database with a single data model is relatively straightforward. But companies today usually run multiple databases, employ commercial CRM tools and subscribe to customer data analytics sites. All of this increases the complexity of a business's data ecosystem, reinforcing the need for a robust data inventory management and data tracking tool.

Data inventory management using Blockchain technology—Blockchains coupled with the tools that aggregate metadata from databases are ideally positioned for the task of data inventory management. Blockchains are distributed ledgers of record (LoR),

where copies of the ledger reside on many different computers (“nodes”). When a data entry (“transaction”) onto one of the distributed ledgers is made, all nodes then cross-communicate to achieve a “consensus” about the validity of the new transaction and then each node individually copies (“writes”) it onto the local LoR. If any node is lost or becomes unavailable, the remaining continue to function normally as a distributed community. Sets of transactions are grouped together into a single data structure called a “block”.

Next, blocks accepted onto the blockchain are each hashed and the resulting digital signature (“hash signature” or “signature”) is also stored as part of a block. But, that signature is stored separate to the originating block. Critically important: all hash signatures are written into the next block to the one they derive from. Tampering with any bit of the data on a blockchain can be easily discovered because any change invalidates that block's signature.

This makes blockchains almost impossible to hack, as when a ledger increases in length (the number of blocks) each entry effectively protects the previous, forming an “immutable chain of data blocks” (i.e. “blockchain”). In this way blockchains are a natural technology for managing data inventory, because they implement data integrity and availability at no additional cost. Blockchains are digital accounting tools, and therefore offer exactly the kind of underlying architecture and functionality required to implement data privacy tracking and monitoring.

FIG. 33 illustrates a baseline a meta-data process when a new customer registers for use of the blockchain encrypted fulfillment system in accordance with the present disclosure. Provisioning data inventory management using Blockchain

Implementing data inventory management on the blockchain is a 3-step process:
Step 1—Baselining the data that is collected;
Step 2—Creating the data assets on the blockchain;
Step 3—Putting in place processes to update the data assets whenever the data acquired by the business changes.

Step 1 Baselining Data to be Collected—Ideally data collection should be as automated as possible and not interfere with the actual data itself. For data inventory management, the actual data is not required, but rather the metadata describing the actual data including: what logical data fields are being stored, whether or not the data identifies individuals, which data fields are related to a consumer's personal information, and whether or not particular data fields are generated locally within a organization or supplied by an external vendor.

The first step in baselining of data is to extract relevant metadata from the databases. In SQL databases, the physical data schema provides the names of the fields for each (database) table, table keys and their data types. Annotation of any fields that possibly convey personal information might be needed as part of the baselining process. The metadata we require would usually be located in the logical and the physical database schemas for many well known SQL databases such as Oracle, Postgres and MySQL and also available this way for many No-SQL (document) databases like MongoDB.

Provisioning data inventory management using Blockchain-Implementing data inventory management on the blockchain is a 3-step process:
Step 1—Baselining the data that is collected;
Step 2—Creating the data assets on the blockchain;
Step 3—Putting in place processes to update the data assets whenever the data acquired by the business changes.

Step 1 Baselining Data to be Collected—Ideally data collection should be as automated as possible and not interfere with the actual data itself. For data inventory management, the actual data is not required, but rather the metadata describing the actual data including: what logical data fields are being stored, whether or not the data identifies individuals, which data fields are related to a consumer's personal information, and whether or not particular data fields are generated locally within a organization or supplied by an external vendor.

The first step in baselining of data is to extract relevant metadata from the databases. In SQL databases, the physical data schema provides the names of the fields for each (database) table, table keys and their data types. Annotation of any fields that possibly convey personal information might be needed as part of the baselining process. The metadata we require would usually be located in the logical and the physical database schemas for many well known SQL databases such as Oracle, Postgres and MySQL and also available this way for many No-SQL (document) databases like MongoDB.

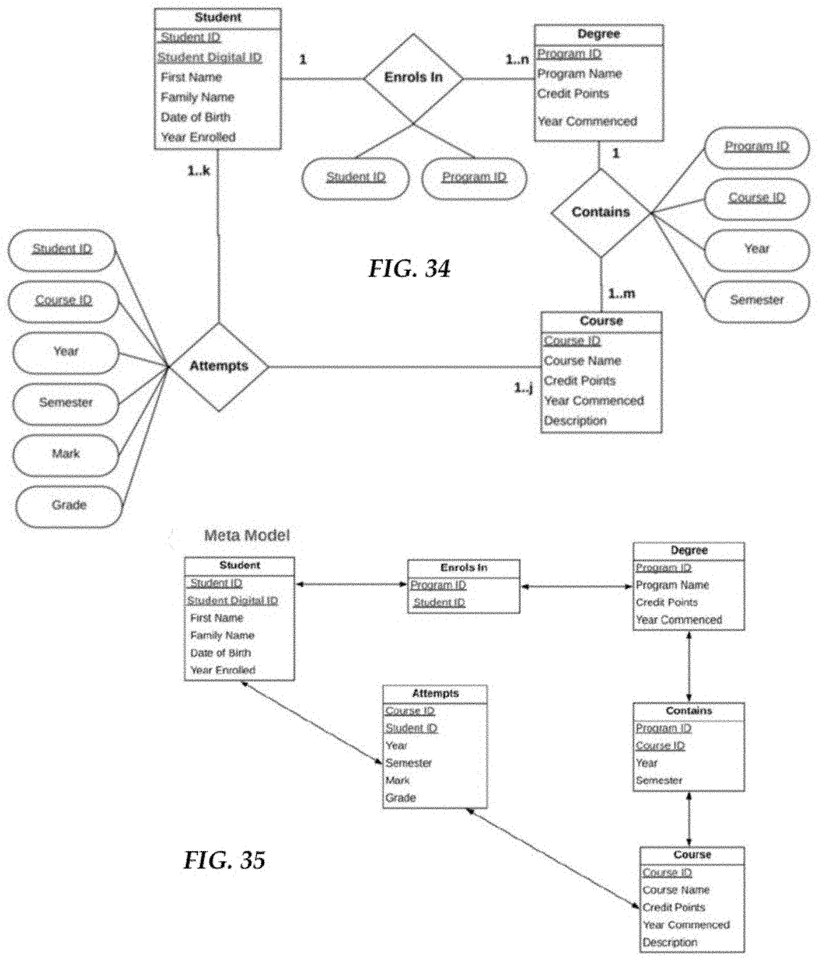

FIG. 34 presents a Chen-style entity-relationship model for use with this present disclosure for enabling a student to enroll in a university as here in described. A Chen style Entity-Relationship model for a student enrolling in a degree with courses. Entities and their attributes are shown in boxes, relationships between entities are shown in diamonds and the attributes of both entities and relationships are in boxes with rounded corners. In a relational database, each Entity and Relation is stored in a table where attributes are the columns of a table and the rows constitute the data, much like in Excel spreadsheets.

The corresponding meta-model is shown in FIG. 11.6. The digital identifier for a student, who plays the role of consumer in this scenario, is in the ‘Student’ table. The personal information for any specific student can be found in the all the attributes of the transitive closure of the ‘Student’ table in the meta-model.

Smart Contracts—The meta model is also used for building smart contracts with ‘the system’ that protect privacy. Smart Contracts are a commonly used mechanism in blockchains to govern the relationship between data systems, or between parties involved in a transaction. Smart Contracts can be written using If X . . . then Y constructs, which makes them highly useful in automating process-oriented workflows, but our smart contracts can be generalised to use crypto conditions, machine learning and AI techniques that are well beyond the current rule based mechanisms used for endpoint protection. In the case of data privacy, Smart Contracts in conjunction with our meta-model can be applied to automate certain data workflows associated with monitoring and policing data flows connected with the personal information of consumers. For instance, a simple Smart Contract using our meta-model could be used to prevent unauthorized users from gaining access to databases containing personal information, by stipulating that If X user credential is not verified, then Y database access is denied. The smart contract and meta-model work symbiotically to ensure that all of the information connected to the consumer, both explicitly and implicitly, is policed.

A second scenario arises when sending data to a third party vendor in a CCPA-compliant fashion. In this scenario, disclosure and opt-in would be required from the consumer. These processes can be automated with a Smart Contract stipulating that If X disclosure form NOT Received then Y data cannot be sent to Vendor. It is important to point out that Smart Contracts are able to automate data and workflow processes because they are part of the blockchain and the blockchain contains the credentials, meta-data and authorizations from the consumer.

Step 3 Updating Data Assets—Any actions that can affect the structure of a data collection trigger updates to the meta-model and subsequently to the meta-data collected for an individual consumer. Because the meta-data stored for an individual on the Blockchain is immutable, any changes to the structure of that meta-data must be done using blockchain transactions. Further, any changes or action on the actual data are recorded on the blockchain as operations linked to meta-data. The two together, that is, changes to the structure of the meta-data and operations linked to meta-data, are the Blockchain Ledger of Record for the privacy data.

In effect, with the UZip Privacy Lock, changing either the underlying data or metadata of an enterprise database is automatically tracked by the blockchain, leaving a “trusted” audit trail.

FIG. 35 presents a diagram derived from the entity-relationship models as described above in FIG. 34. The meta-model generated from the tables in the Entity-Relationship model. The edge between the ‘Student’ and ‘Enrolls In’ results from the fact the primary key of ‘Student’ is a part of the key of ‘Enrolls In’. Notice that only by looking at the attributes in the transitive closure can we see the ‘Grade’ for a student, and which any student might consider sensitive data.

Here again, there is the potential to automate certain data processes. Since the UZip Privacy Lock offers a data inventory management system based on blockchain it is therefore possible to run automation using Smart Contracts in data systems using UZip Privacy Lock. For businesses interested in automating CCPA data processes and reporting, UPL offers automation services that reduce costs and time expenditure related to CCPA compliance processes.

Tracking consumer data requests to satisfy current and future regulations—The CCPA has provisions for consumers to make requests regarding their personal data that a business must satisfy within a specified window of time. A data inventory on the blockchain can be used to:

a) Expedite CCPA consumer data requests by using the metadata stored on the blockchain to find every occurrence in the collective data pool held by companies; and

b) Creating an immutable audit trail of the request so that businesses can verify to themselves and to consumers that any request has been satisfactorily fulfilled.

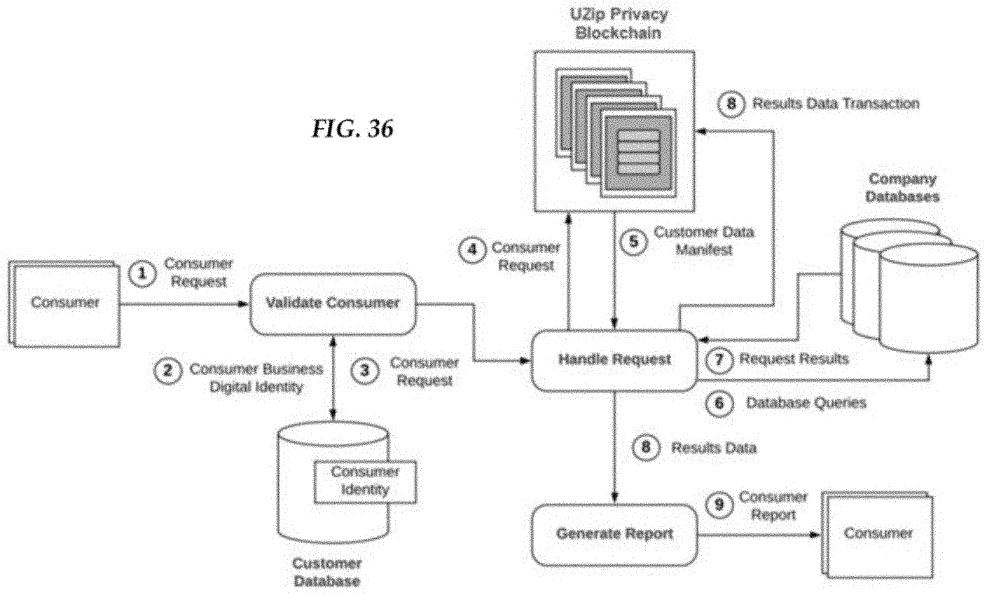

FIG. 36 provides a schematic of a consumer request process for use with the teachings of the present disclosure including a privacy lock blockchain functionality, as herein described.

Consumer Request tracking with UPL proceeds according to the following process:

a) A consumer makes a request to be validated by the business. Consumer credentials are matched against the business' method for customer identification and the associated unique identifiers under which the consumer data is stored are obtained. The Consumer Request is “stamped” onto the blockchain (see below).
b) The request is executed against the current state of the metadata on the blockchain and a manifest of all fields, tables and organization tools (such as CRM tools) where stored customer data is returned. This list is written onto the blockchain and connected directly to the request as part of a comprehensive audit trail.
c) The produced manifest is utilized to service the request by running through it, applying each action required by the request to each database, database table or collection, and management tool. The actions taken on each of the databases, database tables, collections and third party tools are documented and stored on the blockchain against the original request.
d) The request outcomes are sent to the consumer and all outputs are written to the blockchain.

Reports may be generated showing this process to business administrators and consumers. In Step 1 the request is received into the workflow and in Step 2 the consumer's business identity is retrieved. The diagram in FIG. 2.1 shows just one example of how a consumer's identity can be validated. In practice, the consumer's identity can be validated in a number of different ways but whichever way it is done we always assume that we end up with a unique digital identity for the customer.

We do not store any sensitive data on the blockchain. Recall that data stored on the blockchain is metadata specifying what data has been stored about a consumer. In Step 4 the user request is formulated as a request on the blockchain and the data manifest is returns. The data manifest returned (Step 5) is the subset of the attributes in the meta-model relevant to consumer request. The manifest is used to query the databases and tables required to satisfy the request (Step 6) and reported to back to the consumer along with the blockchain certificates (Steps 7 and 8).

The blockchain is also used to store an audit trail for a consumer against their original request and this audit trail uses a generated digital identity and is anonymous to the business as well. The initial request is stored on the blockchain, and linked back to the consumer's stored meta-data via the consumer's digital identity. Each stage of the request handling sketched in FIG. 6 is logged as a transaction on the blockchain finalized on the blockchain.

The UZip Privacy Lock is an innovative blockchain-backed data platform that comprehensively addresses the need to bring data systems for businesses into compliance with the 2020 California Consumer Privacy Act. UPL offers a unique blockchain-microservices integrated architecture that allows for flexible design implementation of CCPA compliance across different business scenarios. This paper has described the architecture of UPL and demonstrated why this product is uniquely positioned to leverage blockchain technology for CCPA compliance.

The value of the BCC main platform along with the DUIS platform is to eliminate numerous intermediaries, optimize costs, build simple and transparent ways of forming supply and payment chains. Using all solutions (economic, social and technical) together, it is possible to achieve a completely new level of the agricultural products disposal and farming activities by the mechanisms of adding value to the system. Value is not taken anywhere, it is formed by the community itself through active use of the payment instruments and technologies.

FIG. 37 illustrates a process of the presently disclose subject matter for publishing real time data to a message queuing telemetric transport (MQTT) process according to the present teachings. An RTK station will Publish real-time data to JWCLab MQTT1 Broker. Flight control devices (Android/iOS/Window) within a radius of 10 Km (center is RTK station) will Subscriber to receive RTK data from JWCLab MQTT Broker and adjust errors for its Drone.
Each RTK station will help one or more drones to adjust position errors within a radius of 10 Km.
Drones outside the 10 Km radius can also use this RTK data, but the accuracy is reduced.

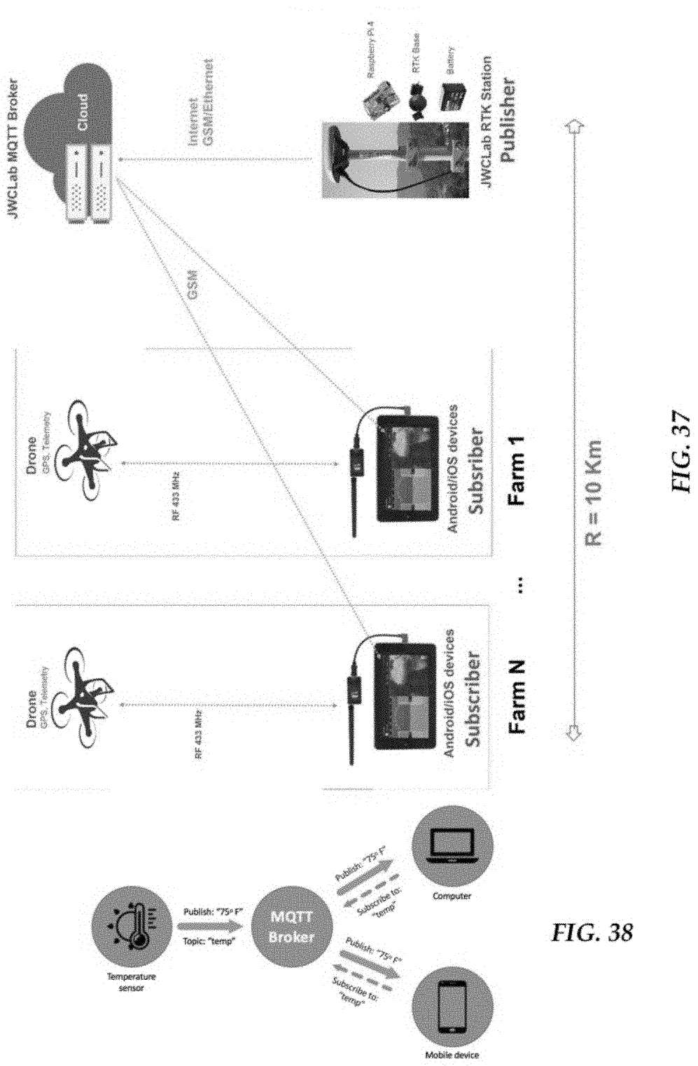

FIG. 38 illustrates an exemplary embodiment of a MQTT process consistent with the teachings of the present disclosure for use in the drone communication system of FIG. 37.

Background info on MQTT (Message Queuing Telemetry Transport). MQTT is a lightweight publish and subscribe system where electronic devices can publish and receive messages as clients from MQTT Broker. MQTT operates on the Internet infrastructure, MQTT is designed for constrained devices with low-bandwidth and raltime (IoTs, RTK devices, etc). More about MQTT: https://github.com/mqtt/mqtt.github.io/wiki

All references, including publications, patent applications, and patents, cited herein are hereby incorporated by reference to the same extent as if each reference were individually and specifically indicated to be incorporated by reference and were set forth in its entirety herein.

The methods, systems, process flows and logic of disclosed subject matter associated with a computer readable medium may be described in the general context of computer-executable instructions, such as, for example, program modules, which may be executed by a computer. Generally, program modules may include routines, programs, objects, components, data structures, etc. that perform particular tasks or implement particular abstract data types. The disclosed subject matter may also be practiced in distributed computing environments wherein tasks are performed by remote processing devices that are linked through a communications network. In a distributed computing environment, program modules may be located in local and/or remote computer storage media including memory storage devices.

The detailed description set forth herein in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein, but is to be accorded the widest scope consistent with the principles and novel features disclosed herein. It is contemplated that additional embodiments are within the spirit and true scope of the disclosed subject matter.

A spraying aerial vehicle (Agricultural Drone), comprising: a central rotor assembly configured to provide vertical thrust; a fuselage frame having a longitudinal axis mounted to the central rotor assembly; a plurality of rotors smaller than said central rotor mounted to said fuselage by a frame, comprises: a propeller; an electrical motor; an electronic speed controller; a flight controller (means for controlling the rotation speed of the central rotor and the smaller rotors); and a propulsion system for powering said central rotor, said smaller rotors and said flight controller; a spraying system (means for pesticides and fertilizer spraying).

The spraying aerial vehicle, wherein the central rotor assembly comprises: a central rotor; a direct drive electrical motor for rotating the central rotor; a ducted fan housing enclosing the central rotor.

The spraying aerial vehicle, wherein the central rotor assembly comprises: a central rotor; a combustion engine for rotating the central rotor; a ducted fan housing enclosing the central rotor; and means for transferring rotational energy from the combustion engine to the rotors

The spraying aerial vehicle, wherein the central rotor assembly comprises: a plurality of counter rotating rotors; a ducted fan housing enclosing the central rotor; and an electrical motor for powering the central rotor assembly; means for transferring rotational energy from the electrical motor to the rotors and turning the rotors in opposite directions.

The spraying aerial vehicle, wherein the central rotor assembly comprises: a plurality of counter rotating rotors; a ducted fan housing enclosing the central rotor; and a combustion engine for powering the central rotor assembly; means for transferring rotational energy from the combustion engine to the rotors and turning the rotors in opposite directions.

The spraying aerial vehicle, wherein the smaller rotors assembly comprises an enclosing ducted fan housing.

The spraying aerial vehicle, wherein the spraying system comprises: pesticides or fertilizer tanks; pumps; flow measurement; a spraying rig; spraying nozzles.

The spraying aerial vehicle of claim 20, wherein the propulsion system assembly comprises: a fossil fuel tank; a combustion engine; a voltage regulator; a generator; a rechargeable electrical energy storage; and control means for charging, discharging the electrical energy storage and distributing electrical energy.

A delivery unmanned aerial vehicle, comprising: a central rotor assembly configured to provide vertical thrust; a fuselage frame having a longitudinal axis mounted to the central rotor assembly; a plurality of rotors smaller than said central rotor mounted to said fuselage by a frame, comprises: a propeller; an electrical motor; an electronic speed controller; a flight controller (means for controlling the rotation speed of the central rotor and the smaller rotors); and a propulsion system for powering said central rotor, said smaller rotors and said flight controller.

The delivery unmanned aerial vehicle, wherein the central rotor assembly comprises: a central rotor; a direct drive electrical motor for rotating the central rotor; a ducted fan housing enclosing the central rotor.

The delivery unmanned aerial vehicle, wherein the central rotor assembly comprises: a central rotor; a combustion engine for rotating the central rotor; a ducted fan housing enclosing the central rotor; and means for transferring rotational energy from the combustion engine to the rotors.

The delivery unmanned aerial vehicle, wherein the central rotor assembly comprises: a plurality of counter rotating rotors; a ducted fan housing enclosing the central rotor; and an electrical motor for powering the central rotor assembly; and means for transferring rotational energy from the electrical motor to the rotors and turning the rotors in opposite directions.

The delivery unmanned aerial vehicle, wherein the central rotor assembly comprises: a plurality of counter rotating rotors; a ducted fan housing enclosing the central rotor; and a combustion engine for powering the central rotor assembly; and means for transferring rotational energy from the combustion engine to the rotors and turning the rotors in opposite directions.

The delivery unmanned aerial vehicle, wherein the smaller rotors assembly comprises an enclosing ducted fan housing.

The delivery unmanned aerial vehicle, wherein the propulsion system assembly comprises: a fossil fuel tank; a combustion engine; a voltage regulator; a generator; a rechargeable electrical energy storage; and control means for charging, discharging the electrical energy storage and distributing electrical energy.

The delivery unmanned aerial vehicle, comprising a house designing for containing delivery goods.

What is claimed is:

1. An aerial vehicle, comprising:
a central rotor assembly configured to provide vertical thrust;
a fuselage having a longitudinal axis mounted to the central rotor assembly;
a plurality of rotors smaller than said central rotor mounted to said fuselage by a frame, comprises:
a propeller
an electrical motor
an electronic speed controller
a flight controller (means for controlling the rotation speed of the central rotor and the smaller rotors); and
a propulsion system for powering said central rotor, said smaller rotors and said flight controller.

2. The aerial vehicle of claim 1, wherein the central rotor assembly comprises:
a central rotor;
a direct drive electrical motor for rotating the central rotor
a ducted fan housing enclosing the central rotor.

3. The aerial vehicle of claim 1, wherein the central rotor assembly comprises:
a central rotor;
a combustion engine for rotating the central rotor
a ducted fan housing enclosing the central rotor.
means for transferring rotational energy from the combustion engine to the rotors.

4. The aerial vehicle of claim 1, wherein the central rotor assembly comprises:
a plurality of counter rotating rotors;
a ducted fan housing enclosing the central rotor; and
an electrical motor for powering the central rotor assembly
means for transferring rotational energy from the electrical motor to the rotors and turning the rotors in opposite directions.

5. The aerial vehicle of claim 1, wherein the central rotor assembly comprises:
a plurality of counter rotating rotors;
a ducted fan housing enclosing the central rotor; and
a combustion engine for powering the central rotor assembly
means for transferring rotational energy from the combustion engine to the rotors and turning the rotors in opposite directions.

6. The aerial vehicle of claim 2, comprising control vanes connected to the ducted fan housing by a frame comprises:
a plurality of airfoil shape vanes; and
means for changing the setting angle of the vanes.

7. The aerial vehicle of claim 1, wherein the smaller rotors assembly comprises an enclosing ducted fan housing.

8. The aerial vehicle of claim 1, wherein the propulsion system assembly comprises:
a fossil fuel tank;
a combustion engine;
a voltage regulator
a generator;
a rechargeable electrical energy storage; and
control means for charging, discharging the electrical energy storage and distributing electrical energy.

9. The aerial vehicle of claim 1, further comprising a parachute designing to fire and extract vertically.

10. An aerial, ground and water-borne vehicle, comprising:
a central rotor assembly configured to provide vertical thrust;
a fuselage having a longitudinal axis mounted to the central rotor assembly;
a plurality of rotors smaller than said central rotor mounted to said fuselage by a frame, comprises:
a propeller
an electrical motor
an electronic speed controller
a flight controller (means for controlling the rotation speed of the central rotor and the smaller rotors); and
a propulsion system for powering the central rotor, the smaller rotors and flight controller.
a skirt bag creating air cushion to lift said aerial, ground and water-borne vehicle.

11. The aerial, ground and water-borne vehicle of claim 1, wherein the central rotor assembly comprises:
a central rotor;
a direct drive electrical motor for rotating the central rotor
a ducted fan housing enclosing the central rotor.

12. The aerial, ground and water-borne vehicle of claim 10, wherein the central rotor assembly comprises:
a central rotor;
a combustion engine for rotating the central rotor
a ducted fan housing enclosing the central rotor.
means for transferring rotational energy from the combustion engine to the rotors.

13. The aerial, ground and water-borne vehicle of claim 10, wherein the central rotor assembly comprises:
a plurality of counter rotating rotors;
a ducted fan housing enclosing the central rotor; and
an electrical motor for powering the central rotor assembly
means for transferring rotational energy from the electrical motor to the rotors and turning the rotors in opposite directions.

14. The aerial, ground and water-borne vehicle of claim 10, wherein the central rotor assembly comprises:
a plurality of counter rotating rotors;
a ducted fan housing enclosing the central rotor; and
a combustion engine for powering the central rotor assembly
means for transferring rotational energy from the combustion engine to the rotors and turning the rotors in opposite directions.

15. The aerial, ground and water-borne vehicle of claim 12, comprising control vanes connected to the ducted fan housing by a frame comprises:
a plurality of airfoil shape vanes; and
means for changing the setting angle of the vanes.

16. The aerial, ground and water-borne vehicle of claim 10, wherein the smaller rotors assembly comprises an enclosing ducted fan housing.

17. The aerial, ground and water-borne vehicle of claim 10, wherein the propulsion system assembly comprises:
a fossil fuel tank;
a combustion engine;
a voltage regulator
a generator;
a rechargeable electrical energy storage; and
control means for charging, discharging the electrical energy storage and distributing electrical energy.

18. The aerial, ground and water-borne vehicle of claim 10, further comprising a parachute designing to fire and extract vertically.

19. A propulsion system, comprising:
a fossil fuel tank;
a combustion engine;
a voltage regulator
a generator;
load;
a rechargeable electrical energy storage; and
control means for charging, discharging the electrical energy storage and distributing electrical energy.
